(19) United States
(12) Patent Application Publication
(10) Pub. No.: US 2023/0162441 A1
(43) Pub. Date: May 25, 2023

(54) GENERATING AN ABOVE GROUND BIOMASS PREDICTION MODEL

(71) Applicant: DENDRA SYSTEMS LTD., Oxford (GB)

(72) Inventor: Yuri SHENDRYK, Sydney (AU)

(21) Appl. No.: 18/058,536

(22) Filed: Nov. 23, 2022

Related U.S. Application Data
(60) Provisional application No. 63/264,569, filed on Nov. 24, 2021.

(51) Int. Cl. G06T 17/05; G06T 7/70

(52) U.S. Cl. CPC G06T 17/05; G06T 7/70; G06T 2207/10036; G06T 2207/10044; G06T 2207/10028

(57) ABSTRACT

A method and apparatus of a device for generating an above ground biomass density prediction model is described. In an exemplary embodiment, the device receives a first set of satellite and optionally environmental data for the target landmass. In addition, the device trains an above ground biomass density model using at least the satellite data and Light Detection and Ranging (LIDAR) data. Furthermore, the device applies the above ground biomass density model using a second set of satellite and environmental biomass to generate the ground biomass density map.

### CROSS-REFERENCE TO RELATED APPLICATION

This application claims priority to U.S. Provisional Application No. 63/264,569 filed on Nov. 24, 2021, the entire contents of which are incorporated herein by reference.

### FIELD OF INVENTION

This invention relates generally to model generation and more particularly to generating an above ground biomass density prediction model.

### BACKGROUND OF THE INVENTION

An accurate and spatially explicit estimation of biomass is required for sustainable forest management, prevention of biodiversity loss, and carbon accounting for climate change mitigation.

### SUMMARY OF THE DESCRIPTION

A method and apparatus of a device for generating an above ground biomass density (AGBD) prediction model is described. In an exemplary embodiment, the device receives a set of satellite and environmental data (i.e. elevation, land cover, climate) for the target landmass. Next, the device trains an AGBD model using satellite and environmental and a sample of Light Detection and Ranging (LiDAR) derived AGBD data. Finally, the device applies the AGBD model to a new set of satellite and environmental data to generate the AGBD prediction map.

Other methods and apparatuses are also described.

### BRIEF DESCRIPTION OF THE DRAWINGS

The present invention is illustrated by way of example and not limitation in the figures of the accompanying drawings in which like references indicate similar elements. The patent or application file contains at least one drawing executed in color. Copies of this patent or patent application publication with color drawing(s) will be provided by the Office upon request and payment of the necessary fee.

The present invention is illustrated by way of example and not limitation in the figures of the accompanying drawings in which like references indicate similar elements.

FIG. 1 is an illustration of one embodiment of a system that generates an above ground biomass density (AGBD) prediction model.

FIG. 2 is an illustration of an AGBD map of a landmass.

FIG. 3A is a flow diagram of one embodiment of a process to generate an AGBD prediction model for a targeted landmass using satellite and DEM data.

FIG. 3B is a flow diagram of one embodiment of a process to generate an AGBD prediction model for a targeted landmass using satellite, elevation and climate data.

FIG. 4 is an illustration of one embodiment of a land cover of Australia and conterminous United States.

FIG. 5 is an illustration of one embodiment of GEDI data between January-December after filtering within Australia and conterminous United States.

FIG. 6A is an illustration of one embodiment of a machine learning workflow for AGBD estimation.

FIG. 6B is an illustration of one embodiment of a workflow for the prediction and mapping of the AGBD and its uncertainty over Australia and the United States for 2020.

FIG. 7 is an illustration of AGBD map validation procedure.

FIG. 8 is an illustration of third-party AGBD maps.

FIG. 9 is an illustration of one embodiment of a series of plots showing the accuracy of AGBD estimation.

FIG. 10 is an illustration of one embodiment of prediction maps of AGBD.

FIG. 11 is an illustration of one embodiment of a validation of the AGBD map against 3^{rd} party AGBD maps.

FIG. 12 illustrates one example of a typical computer system, which may be used in conjunction with the embodiments described herein.

### DETAILED DESCRIPTION

A method and apparatus of a device for generating an above ground biomass prediction model is described. In the following description, numerous specific details are set forth to provide a thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in a different order. Moreover, some operations may be performed in parallel rather than sequentially.

The terms “server,” “client,” and “device” are intended to refer generally to data processing systems rather than specifically to a particular form factor for the server, client, and/or device.

Forests play a critical role in Earth's climate as they provide an overall carbon sink. It was estimated that global forests absorb twice as much carbon as they emit each year from deforestation and other disturbances. Therefore, as the global community works towards net zero carbon solutions, it is vital to know how much carbon is stored in forest biomass and monitor its change. While there are multiple methods for estimating forest biomass, spaceborne remote sensing is currently the only practical tool for spatially explicit monitoring of AGB at regional and global scales.

A method and apparatus of a device for generating an above ground biomass prediction model is described. An accurate and spatially explicit estimation of biomass is critical for understanding terrestrial carbon dynamics and clarifies the role of natural ecosystems in climate change mitigation. Terrestrial ecosystems such as forests, shrublands, and grasslands play a fundamental role in Earth's climate, acting as an overall carbon sink. For example, it was estimated that global forests absorb twice as much carbon as they emit each year from deforestation and other disturbances. Therefore, to facilitate the global community's efforts in restoring and protecting forests and other carbon sinks, it is vital to know how much biomass is stored in terrestrial ecosystems and monitor its change over time.

Total plant biomass consists of aboveground biomass (AGB; e.g., trees, shrubs, and grasses) and belowground biomass (e.g., living roots). Generally, AGB is estimated due to the difficulty of measuring belowground biomass in the field. There are multiple approaches for estimating AGB, including field and remote sensing-based methods. The most accurate, albeit time-consuming and small-scale method to estimate AGB is field-based destructive sampling. Destructive sampling is further commonly used to generate allometric models based on tree measurements such as diameter at breast height (DBH), height, and volume. In contrast, remote sensing methods informed using allometric models can provide large scale AGB estimates and generally rely on passive (e.g., multispectral) or active (synthetic-aperture radar (SAR) and Light Detection and Ranging (LiDAR)) sensors. Remote sensing data can be collected from field-based, airborne and spaceborne platforms, with LiDAR sensors commonly providing the most accurate AGB estimates.

Spaceborne remote sensing is currently the most practical tool for spatially explicit monitoring of AGB at continental and global scales. AGB estimation methods using spaceborne remote sensing have substantially evolved in the last five decades, with multispectral (e.g., Landsat, MODIS), SAR (e.g., ALOS PALSAR, ENVISAT ASAR), and LiDAR (e.g., GLAS, ICESat) sensors being most commonly used for AGB estimation. However, the lack of field data and allometric models for calibration and validation, limited coverage as well as low temporal and spatial resolutions hindered their application for tracking progress toward vegetation-based climate change mitigation goals. Nevertheless, monitoring AGB and its change using spaceborne remote sensing has become increasingly feasible over large areas in unprecedented detail. This has been mainly driven by the abundance and open access to high-resolution, multi-source satellite imagery. Specifically, the near-daily availability of satellite multispectral imagery and SAR imagery that overcomes cloud-cover issues enable the mapping of vegetation disturbances down to 3 m resolution. This, in turn, creates opportunities for much more timely, transparent, and efficient monitoring of AGB at high resolution for national-level carbon budget inventories and large area comparative studies.

Recent progress in AGB estimation using spaceborne remote sensing data would be impossible without the availability of allometric models and field measurements that they rely on. Field-measured biomass is an integral component of earth observation (EO) derived AGB maps allowing the conversion of remote sensing signals into absolute measurements of biomass (e.g., Megagram (Mg)) and its density (e.g., Mg/ha) that permit time and space comparisons. Unfortunately, manual AGB measurements in the field are time-consuming and require either destructive sampling or measurements of common tree parameters, such as DBH, height, and volume. To alleviate this problem, Global Ecosystem Dynamics Investigation (GEDI) sensor was recently launched and installed at the International Space Station. GEDI collects full-waveform LiDAR data to produce accurate estimates of AGB density (AGBD) within footprints of ˜25 m in diameter at the near-global scale. Models to produce AGBD estimates from GEDI were developed from discrete-return airborne LiDAR data collocated with field measurements, with the former further used to simulate GEDI waveforms. However, GEDI is not a wall-to-wall instrument, and even after a full year of data collection, there are still significant coverage gaps, especially at the equator.

Generally, the derivation of national and global level wall-to-wall AGBD products relies on spaceborne remote sensing data at a resolution as fine as 30 m informed using field-measured biomass data. For example, there are Climate Change Initiative (CCI) global AGBD maps at 100 m resolution derived from satellite SAR imagery for multiple years as well as multi-year Landsat and PlanetScope time-series derived AGBD products over Canada (30 m) and Peru (100 m), respectively. There are also multiple wall-to-wall AGBD products in the works that rely specifically on GEDI data. For instance, NASA's Jet Propulsion Laboratory (JPL) 2020 Global Biomass Dataset and an enhanced biomass product that fuses GEDI, TanDEM-X, and Landsat data). However, some existing and upcoming AGBD products often rely on proprietary EO data (e.g., TanDEM-X, ALOS-2 PALSAR-2, PlanetScope, etc.), complicating their usability. Furthermore, satellite data derived AGBD products are prone to saturation in regions of high biomass and are difficult to replicate without having access to the privately-owned airborne LiDAR data and field inventory measurements used in their development.

To date, regression analysis, k-nearest neighbors, and random forest were the most popular methods for large scale estimation of AGBD using satellite imagery, while more advanced machine learning approaches (e.g., gradient boosting and convolutional neural networks (CNNs)) are still being underutilized. In one embodiment, gradient boosting was used to estimate AGBD mainly due to its fast-training speed, interpretability, and capability to handle large-scale multi-dimensional and multi-type (e.g., categorical and continuous) data. Gradient boosting uses an ensemble of decision trees for predictions. However, unlike random forest, the decision trees in gradient boosting are generally shallow and added sequentially, with each new tree built to improve the performance of the previous trees. As a result, gradient boosting showed good potential in multiple benchmarks and, while being more interpretable and faster to train, it can outperform CNN models in the case of small training samples of remote sensing data.

In one embodiment, a gradient boosting approach for large area AGBD mapping that solely relies on open access EO data is proposed. The applicability of the proposed approach in different geographic regions is tested and compared against the existing global AGBD product. For this, GEDI data were combined with Sentinel-1 SAR, Sentinel-2 multispectral, elevation, and land cover data to produce wall-to-wall AGBD maps of Australia and the United States for 2020. This data fusion was performed to produce AGBD maps that are more accurate and exhibit less saturation in high biomass areas than what is possible with any single data source alone.

Accurate mapping of forest aboveground biomass (AGB) is critical for carbon budget accounting, sustainable forest management as well as for understanding the role of forest ecosystems in climate change mitigation. In one embodiment, spaceborne Global Ecosystem Dynamics Investigation (GEDI) LiDAR and Sentinel-2 multispectral data were used in combination with elevation and climate data to produce a wall-to-wall AGBD map of a targeted landmass (e.g., Australia) that is more accurate and with higher spatial and temporal resolution than what is possible with any one data source alone. For example, and in one embodiment, the AGBD map was produced that covers the whole extent of Australia at 100 m spatial resolution for the Austral winter (June-August) of 2020. To produce this map Copernicus Sentinel-2 composite, Digital Elevation Model (DEM), and long-term climate variables were trained with samples from the GEDI Level 4A product.

In one embodiment, a prediction model device uses the GEDI LiDAR and Sentinel-2 multispectral data were used in combination with elevation and climate data to produce a decision tree model (e.g., a gradient boosting model) that can be used for the targeted landmass. Applying statistics to the decision tree model generates the AGBD map.

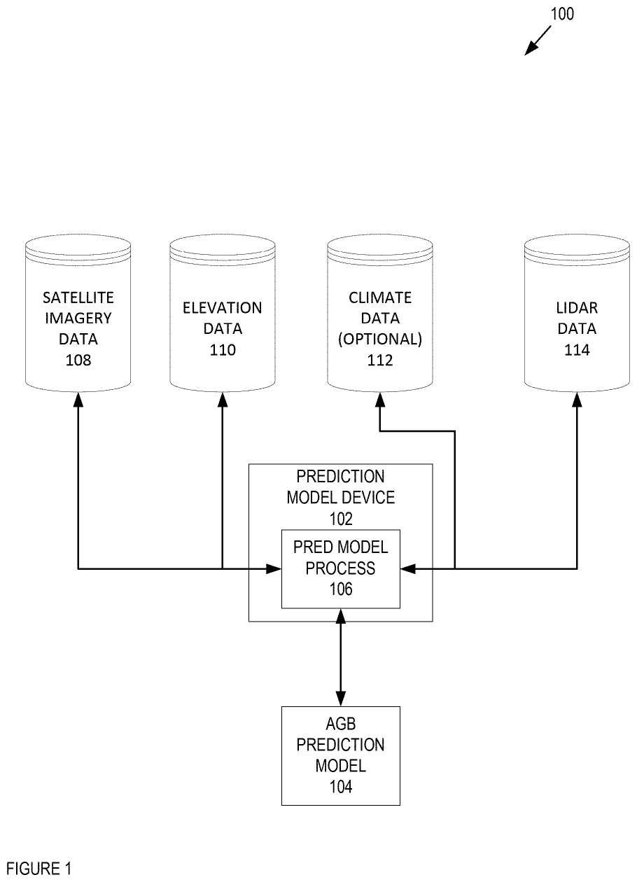

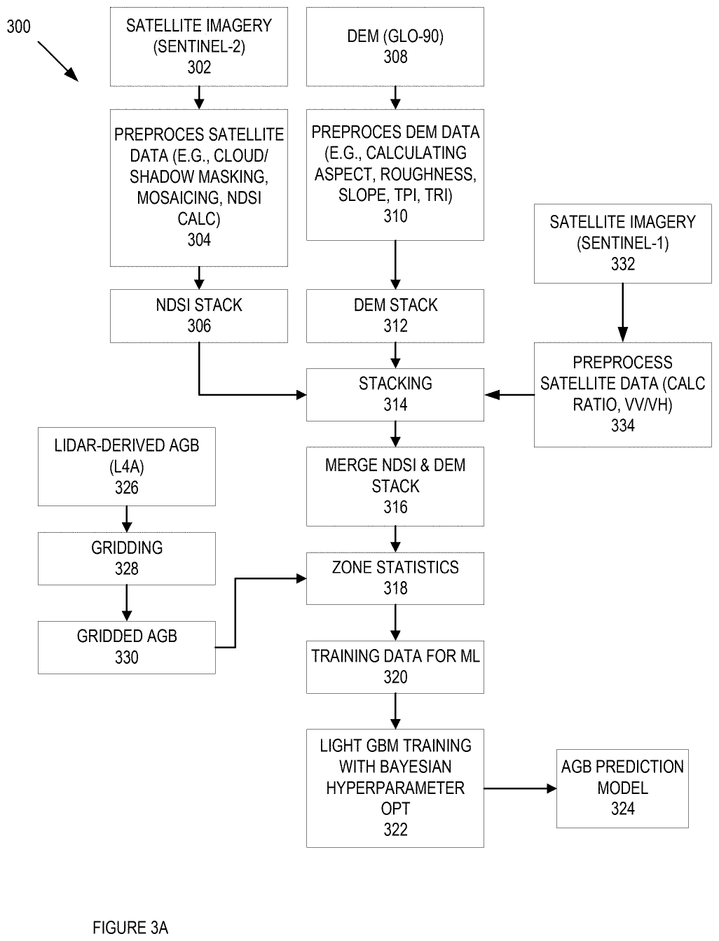

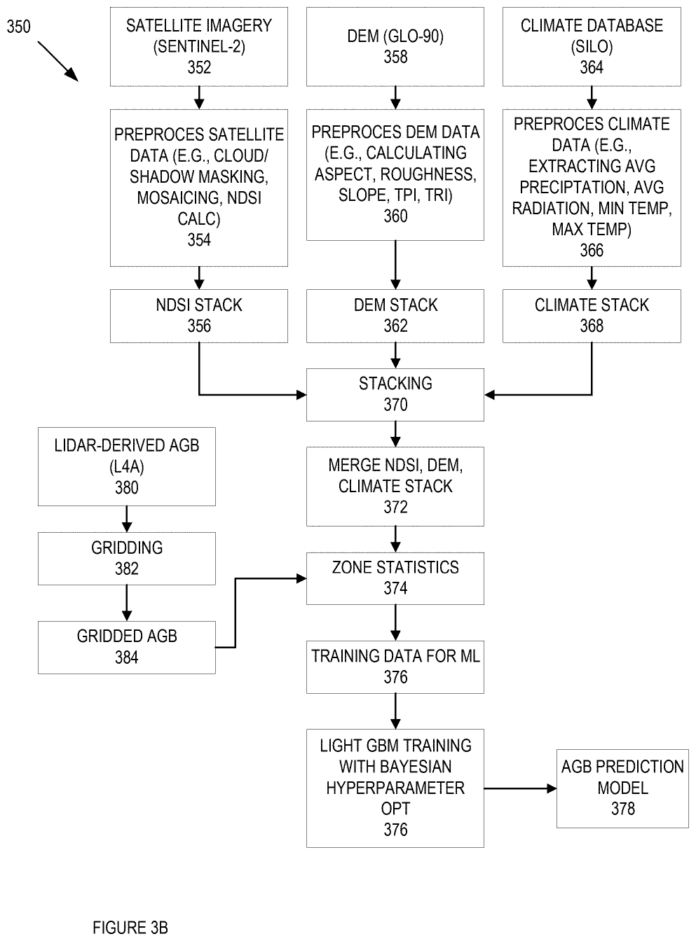

FIG. 1 is an illustration of one embodiment of a system 100 that generates an AGBD prediction model. In FIG. 1, the system 100 includes a prediction model device 102 that is used to generate an AGBD model for a given region. In this embodiment, the prediction model device 102 can be a personal computer, laptop, server, mobile device (e.g., smartphone, laptop, personal digital assistant, music playing device, gaming device, etc.), and/or any device capable of processing data. In one embodiment, the prediction model device 102 uses satellite imagery data 108, elevation data 110, optionally climate data 112, and Light Detection and Ranging (LIDAR) data 114 to generate the AGBD prediction model 104, where each of the input data is particular to landmass. In one embodiment, the system 100 can generate the AGBD prediction model without using the climate data 112 (e.g., FIG. 3A below) or using the climate data (e.g., FIG. 3B below). The landmass can be a region, country, collection of countries, continent, or another type of landmass. In this embodiment, the satellite imagery data 108 is one of Sentinel-1 synthetic-aperture data, Sentinel-2 multispectral data, other satellite data, or a combination thereof. In addition, and in this embodiment, the elevation data 110 is a digital elevation model and the climate data 112 can include scientific information for land owners (SILO) data. Furthermore, the prediction model device 102 uses LIDAR data 114 to train the machine learning model (further described in FIG. 3 below). As described above, the prediction model 102 uses the input data (e.g., satellite imagery data 108, elevation data 110, LIDAR data 114, and/or optionally the climate data 112) to generate the AGBD prediction model 104. In one embodiment, the AGBD prediction model 104 is a decision tree that can be used to generate a wall-to-wall AGBD map for a targeted landmass. For example, and in one embodiment, the AGBD prediction model 104 is a decision tree representing a collection of rules that take input of satellite, elevation, and/or climate data and can be used to create a wall-to-wall AGBD map for a particular landmass. In this embodiment, a wall-to-wall map means that each subdivision of the map for the landmass has AGBD assigned to that subdivision. In another embodiment, other types of satellite imagery data, climate data, and/or elevation data can be used to generate the AGBD prediction model 104.

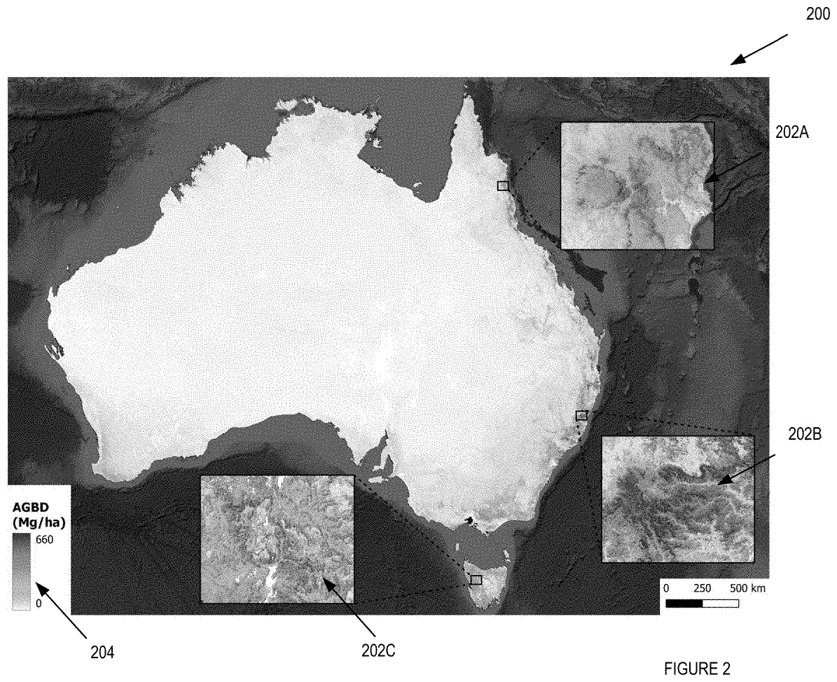

FIG. 2 is an illustration of an AGBD map 200 of a landmass. In one embodiment, the landmass 200 illustrated in FIG. 2 is the Australian continent landmass. In FIG. 2, there are several cells 202A-C that represent different sections of the landmass 200, where each cell 202A-C includes a density map of above ground biomass for that cell. For example, and in one embodiment, each of the cells 202A-C is a density map of above ground biomass in units of Mg/ha (Megagrams/hectare). In one embodiment, there are cells for each section of land in the landmass 200, where each cell includes a density map. Thus, a wall-to-wall AGBD map can be generated using the prediction model and giving an AGBD map for the entire landmass.

FIG. 3A is a flow diagram of one embodiment of a process 300 to generate an AGBD prediction model for a target landmass. In one embodiment, a prediction model device is used to generate the AGBD prediction model, such as the prediction model device 102 as described in FIG. 1 above. In FIG. 3A, process 300 begins by receiving the satellite imagery data (302), and DEM data (308) for the target landmass. Process 300 preprocesses each of the input data. For example, process 300 preprocess the satellite imagery data by removing the clouds and clouds' shadow from the imagery data at block 304. In addition, process 300 mosaics the imagery data and normalizes the imagery data to produce Normalized Difference Spectral Index (NDSI) data, to produce an NDSI stack of the data for the satellite imagery data at block 306. In one embodiment, seasonal Sentinel-2 composite data was generated using a S2GM mosaicing algorithm and was further used to calculate Normalized Difference Spectral Indices (NDSIs) from the available spectral bands. Execution proceeds to block 314.

At block 308, process 300 receives digital elevation model (DEM) data, where process 300 preprocesses the DEM data to generate aspect, roughness, slope, Topographic Position Index, and Terrain Ruggedness Index data (310). This elevation data is the DEM stack (312). Execution proceeds to block 314. At block 332, process 300 receives additional satellite data, where this satellite data is Sentinel-1 data. Process 300 preprocesses the satellite data at block 334. In one embodiment, process 300 preprocesses the Sentinal-1 satellite data by calculating ratios of the VV band data with the VH band data. Execution proceeds to block 314.

In one embodiment, at block 314, process 300 performs a stacking operation that produces a merged satellite and elevation stack (314). Process 300 generates zone statistics at block 318. In one embodiment, the statistics generated are minimum, maximum, average, and standard deviation. In addition, process 300 receives LIDAR-derived AGBD data (for example, the LIDAR-derived AGBD data can be GEDI L4A data for the target landmass) at block 326. In one embodiment, the LIDAR-derived AGBD data is sparse AGBD data for the target landmass as each LIDAR-derived AGBD data is specific to a small part of the landmass. This is because, in this embodiment, the LIDAR-derived AGBD data is generated from a laser on a satellite and this laser cannot cover a wide area as the laser is a very focused spot of the landmass. Thus, the LIDAR-derived AGBD data covers a small section of the landmass. In addition, process 300 can disregard the LIDAR-derived AGBD data that does not meet certain quality thresholds. For example, and in one embodiment, the LIDAR measurements not meeting the requirements of L4A product quality, and those with a degraded state of pointing or positioning information and an estimated relative standard error in GEDI-derived AGBD exceeding 50% were rejected.

Process 300 grids the landmass at block 328. In one embodiment, process 300 grids the landmass into 200 m×200 m cells. For example, and in one embodiment, process 300 creates approximately 62,000 cells for the Australian landmass. In one embodiment, for each 200 m×200 m cell, process 300 calculates the number of available GEDI measurements and builds models based on the average AGBD of cells containing >5 GEDI measurements. While in one embodiment, the cell size is 200 m×200 m, in alternate embodiment, a different sized cell can be used.

At block 322, the process uses the LIDAR-derived AGBD data as the training data for a machine learning model that will be used as an AGBD prediction model. Process 300 uses light Gradient Boosting Machine (LightGBM) training with Bayesian Hyper parametric optimization to generate the AGBD prediction model. In one embodiment, Bayesian hyperparameter optimization was used to identify the most accurate Light Gradient Boosting Machine (LightGBM) model using 5-fold cross-validation. In one embodiment, the analysis based on the Sentinel-1 and/or Sentinel-2 imagery resulted in AGBD predicted with the coefficient of determination (R2) of 0.68-0.75, root-mean-square error (RMSE) of 40-46 Mg/ha and root-mean-square percentage error (RMSPE) of 47-69%. Model performance improved with the addition of DEM and climate information: AGBD prediction with R2 of 0.77-0.81, RMSE of 35-40 Mg/ha, and RMSPE of 41-52%. Using a SHapley Additive exPlanations (SHAP) approach to explain the output of LightGBM models, it was found that Sentinel-2 derived NDSIs using Red Edge and Short-wave Infrared bands were the most important in predicting seasonal AGBD. In a further embodiment, similar model performance can be expected for the annual prediction of AGBD at a finer resolution (e.g., 100 m) due to the higher density of GEDI measurements. In this embodiment, the methodological opportunities for combining GEDI measurements with satellite imagery and other environmental data toward seasonal AGBD mapping at the regional scale through data fusion. Process 300 outputs the AGBD prediction model at block 328. With the prediction model, process 300 can generate the AGBD map using the AGBD prediction model, such as a wall-to-wall AGBD map of the targeted landmass.

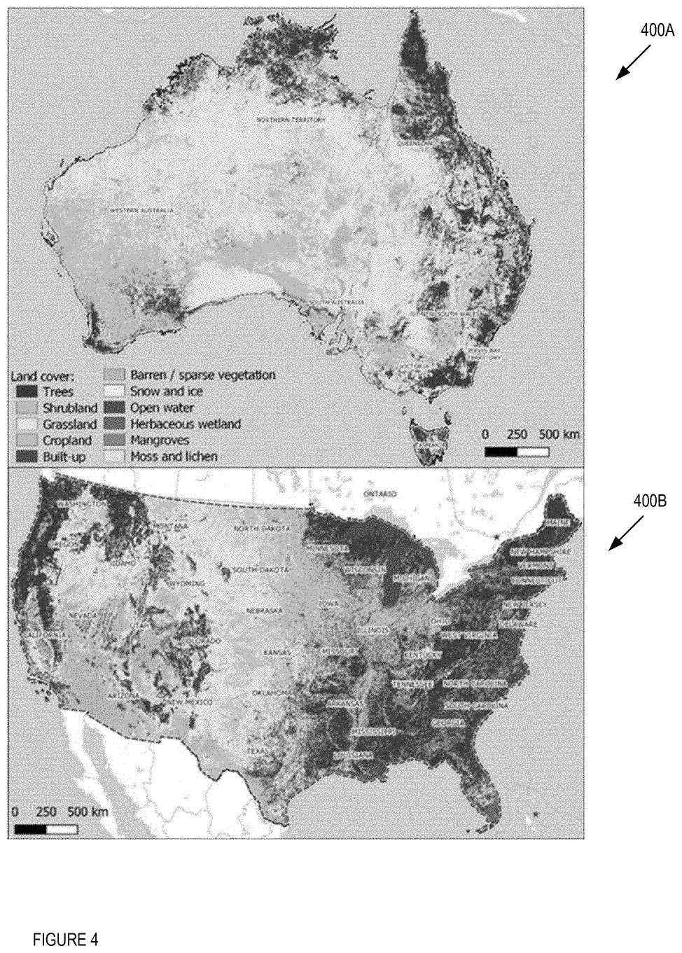

FIG. 4 is an illustration of one embodiment of a land cover of Australia (400A) and the conterminous United States (400B). In one embodiment, The study area spanned Australia (400A) and the main contiguous United States (400B). According to the WorldCover map from 2020, the predominant land covers in Australia were grasslands (54.8%), trees (18.1%), and shrublands (17.0%) in 2020 (400A), with the majority of Australia's trees being broadleaf evergreens, such as eucalypts. In contrast, predominant land covers of the contiguous United States included trees (34.8%), grasslands (31.4%), and croplands (15.9%) (400B). Forests in the east of the United States mainly consist of broadleaf deciduous trees, except for coniferous forests and plantations in the southern region, while trees in the west of the country are mostly coniferous.

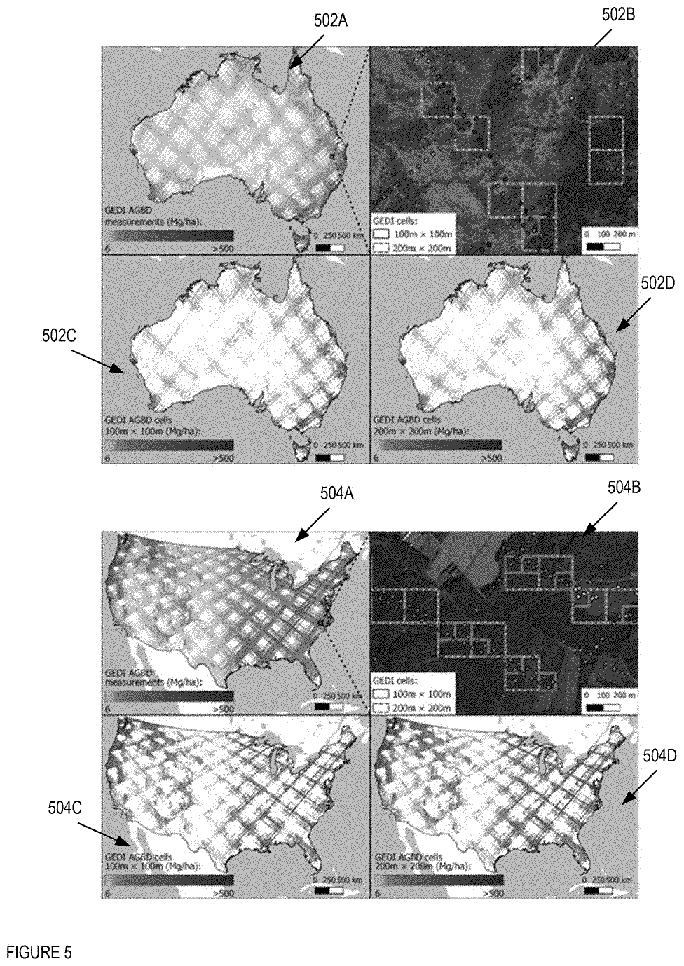

In one embodiment, the data used included the open access EO datasets available through the Oak Ridge National Laboratory Distributed Active Archive Centre (ORNL DAAC) and Google Earth Engine catalog. These included GEDI Level 4A data (Version 2.1) provided by NASA, as well as Sentinel-1 C-band SAR ground range detected imagery, Sentinel-2 Level 2A multispectral imagery, GLO-30 digital elevation model (DEM) and WorldCover land cover product provided by the Copernicus Program. The EO datasets were split into tiles of 300 km×300 km and analyzed using batch processing in Google Earth Engine. FIG. 5 is an illustration of one embodiment of GEDI data between January-December after filtering within Australia (500A) and the conterminous United States (500B). In one embodiment, the GEDI Level 4A data available within Australia and the United States between January and December 2020 were filtered by rejecting all invalid AGBD measurements (‘agbd’=−9999) and measurements not meeting the Level 4A product quality requirements (‘l4_quality_flag’=0 for GEDI variables description). Then unreliable GEDI measurements with a degraded state of positioning (‘degrade_flag’=1) and a relative standard error in GEDI-derived AGBD exceeding 50% (‘agbd_se’/‘agbd’×100>50) were also removed. In addition, GEDI measurements on slopes (derived from GLO-30 DEM)>30° were removed as they previously showed to adversely affect accurate retrieval of both terrain and tree heights. Finally, GEDI data within built-up, barren and sparse vegetation, herbaceous wetland, snow and ice, open water, and moss and lichen land cover according to the WorldCover (e.g., map codes of 50, 60, 70, 80, 90, and 100) product were also rejected. Out of all available GEDI measurements within Australia (442,611,946) and the United States (666,739,999) only 22,839,956 (5.2%) and 44,230,815 (6.6%) remained after the data filtering for further processing, respectively (502A, 504A). All filtered GEDI AGBD measurements used an automatically-selected algorithm setting group for their derivation. In Australia and the United States this resulted in 85% and 15%, and 53% and 47% of GEDI measurements relying on algorithm setting group 1 and 2, respectively. In FIG. 5, the data illustrated is GEDI data available January-December 2020 with Australia: after filtering 502A; zoomed-in area showing GEDI measurement aggregation into cells 502B; (aggregated into 100 m×100 m cells containing ≥4 GEDI measurements 502C; and aggregated into 200 m×200 m cells containing ≥6 GEDI measurements 502D. In addition, FIG. 5 illustrates GEDI data available between January-December 2020 within the United States: after filtering 504A; zoomed-in area showing GEDI measurement aggregation into cells 504B; (aggregated into 100 m×100 m cells containing ≥4 GEDI measurements 504C; and aggregated into 200 m×200 m cells containing ≥6 GEDI measurements 504D.

Given that GEDI footprint centers had horizontal geolocation accuracy of ±10 m, it may be impractical to match GEDI with the EO data directly. In one embodiment, filtered GEDI measurements can be aggregated within 100 m×100 m and 200 m×200 m cells, and the average AGBD was calculated for cells containing ≥4, ≥5, ≥6, and >6, ≥7, ≥8 GEDI measurements, respectively (FIG. 5). These thresholds can be chosen to evaluate the effect of sample size on predictions while preserving the spatial distribution of GEDI data and maximizing the number of cells with at least two GEDI orbital tracks per cell. The GEDI cells containing predominantly shrubland, grassland, cropland, tree, and mangrove land covers were preserved for further analysis. In total, up to 175,502 (100 m×100 m) and 263,699 (200 m×200 m) GEDI cells across Australia, and up to 489,607 (100 m×100 m) and 807,775 (200 m×200 m) GEDI cells across the United States were used to train machine learning models for estimating AGBD.

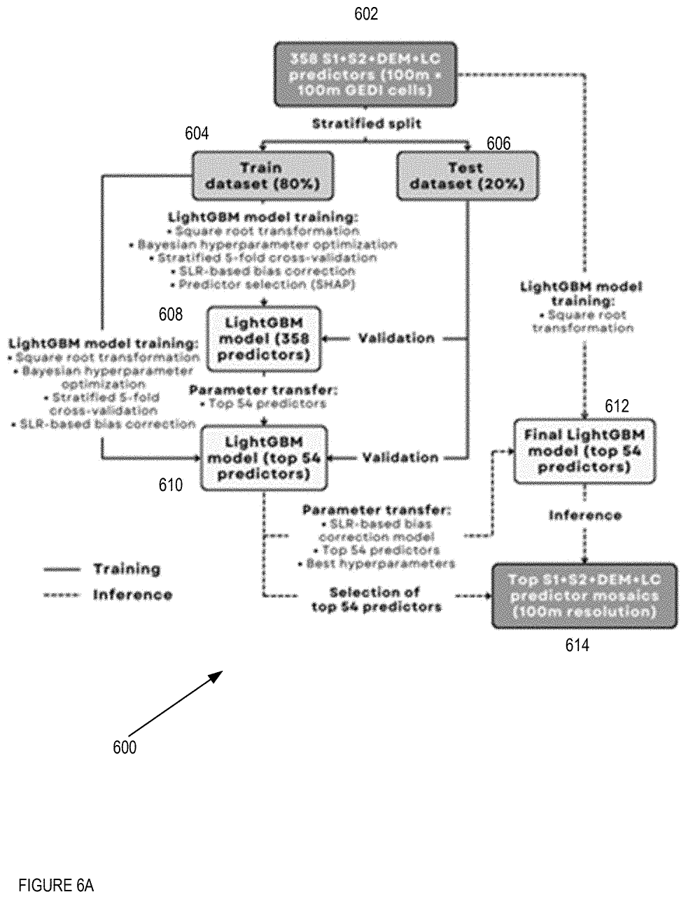

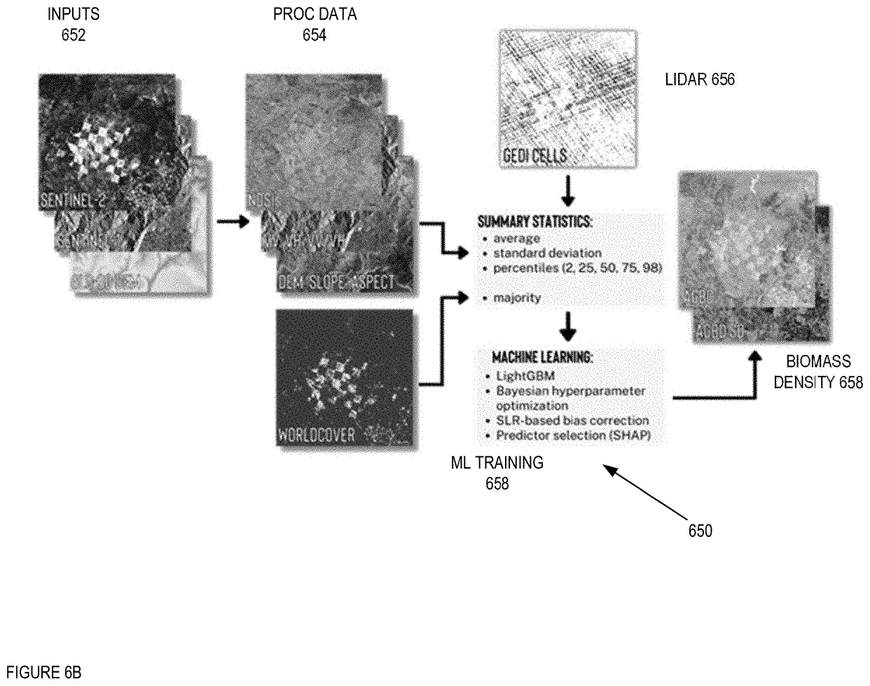

FIG. 6A is an illustration of one embodiment of a machine learning workflow 600 for AGBD estimation. In one embodiment, a prediction model device is used to generate the AGBD prediction model, such as the prediction model device 102 as described in FIG. 1 above. In FIG. 6A, workflow 600 begins by receiving the predictors for the workflow at block 602. In one embodiment, there are 358 S1+S2+DEM+LC predictors as described above in Table 3. In another embodiment, there can be more or fewer predictors. At bloc 604, the workflow 600 trains the dataset. In one embodiment, workflow trains the data set using a LightGBM model training by transforming the AGBD values using a square root transformation, using a Bayesian hyperparameter optimization, a stratified S-fold cross-validation, an SLR-based bias correction, and a predictor selection using SHAP as described above. In one embodiment, a portion of the input dataset is used for the training (e.g., 80%) 604, and another portion of the input dataset is used for validation (e.g., 20%) 606. In another embodiment, different portions of the input dataset can be used for training and validation. While in one embodiment, 54 predictors are chosen in another embodiment, another number of predictors is chosen by workflow 600. At block 608, workflow determines the top N predictors (e.g., 54 predictors) and trains the model. Workflow 600 validates the top N predictors at block 610. Workflow 600 transfers the parameters to the final LightGBM model at block 612. In this embodiment, the final LightGBM model includes the top N (e.g., 54) predictors that have been validated. In a further embodiment, workflow 600 uses predictors from block 602, performs a square root transformation on the predictors, and determines a final model at block 612. In one embodiment, workflow 600 receives parameters transferred from block 610. Thus, at block 612, workflow 600 includes a final trained model that include the trained parameters and final predictors, where this trained model can be used to predict the AGBD. At block 614, workflow 600 outputs the top S1+S2+DEM+LC predictors. In one embodiment, these predictors are for a particular resolution (e.g., 100 m or another resolution).

FIG. 6B is an illustration of one embodiment of a workflow for the prediction and mapping of the AGBD and its uncertainty over Australia and the United States for 2020. In one embodiment, a prediction model device is used to generate the AGBD prediction model, such as the prediction model device 102 as described in FIG. 1 above. In FIG. 6B, process 650 begins by receiving the input at block 652. In one embodiment, the inputs can be Sentinel-1 and/or Sentinel-2 satellite data, DEM data, and/or a combination thereof. These inputs are received by process 650 and processed to output NDSI stack data, VV, VH, and VV/VH data, and DEM slope and aspect data (as needed). In addition, process 650 receives the WorldCover data. Furthermore, process 600 receives the GEDI cells (LIDAR data) at block 656. The process generates summary statistics of the input data, such as average, standard deviation, percentiles (2%, 25%, 50%, 75%, and 98%, and/or other percentiles) and/or other statistics of this data. In one embodiment, process 600 uses these statistics to generate the predictors from this data. In addition, process 600 uses the majority resampling of the WorldCover data as an additional predictor for the ML. At block 658, process 600 determines the machine learning model. In one embodiment, process 600 trains a LightGBM, machine learning model using Bayesian hyperparameter optimization SLR-based bias correction, and predictor selector (SHAP) to train the ML model. Process 600 uses the trained ML model to determine the biomass density at block 658.

In one embodiment, the satellite imagery consisted of C-band SAR imagery collected from Sentinel-1A and 1B satellites and multispectral imagery collected from Sentinel-2A and 2B satellites covering Australia and the United States. Both Sentinel-1 and Sentinel-2 imagery were available in the Google Earth Engine catalog. The dual-polarization (VV-VH) Sentinel-1 ground range detected and logarithmically scaled (dB) SAR imagery was radiometrically calibrated, thermal noise and terrain corrected using Sentinel-1 Toolbox. Sentinel-2 multispectral imagery was limited to 10 spectral bands at 10 m and 20 m resolutions, which were pre-processed using Sen2Cor to Level 2A surface reflectance (Table 1).

TABLE 1
Sentinel-1 and Sentinel-2 imagery used

| | | Central | Spatial |
|---|---|---|---|
| | | wavelength | resolution |
| Satellite | Band name | (nm) | (m) |
| Sentinel-1 | Co-polarized (VV) | 5.5 × 10⁷ | 20 |
| | Cross-polarized (VH) | 5.5 × 10⁷ | 20 |
| Sentinel-2 | Blue (B) | 492 | 10 |
| | Green (G) | 559 | 10 |
| | Red (R) | 665 | 10 |
| | Red Edge 1 (RE1) | 704 | 20 |
| | Red Edge 2 (RE2) | 740 | 20 |
| | Red Edge 3 (RE3) | 781 | 20 |
| | Near-infrared 1 (NIR1) | 833 | 10 |
| | Near-infrared 2 (NIR2) | 864 | 20 |
| | Shortwave infrared 1 | 1612 | 20 |
| | (SW1R1) | | |
| | Shortwave infrared 2 | 2194 | 20 |
| | (SWIR2) | | |

Note:
(central wavelength represents an average of Sentinel-2A and 2B imagery)

To generate spatially explicit estimates of AGBD across Australia and the United States, both Sentinel-1 and Sentinel-2 imagery were reduced to annual median composites within 300 km×300 km tiles, and then mosaicked to the full extent of the countries. The median compositing was used to reflect a typical appearance of the landscape in 2020 while preserving original pixel values. For this, the available images of Sentinel-1 and Sentinel-2 imagery between January and December 2020 were used. Sentinel-1 imagery was composited by taking a median of each band of all images in descending orbit for Australia and ascending orbit for the United States at the resolution of 20 m. Sentinel-1 mosaic was also used to calculate VV/NH ratio, as it has shown to be suitable for monitoring forest phenology.

In contrast, Sentinel-2 imagery was first masked from clouds and cloud shadows, where clouds were identified from the Sentinel-2 cloud probability dataset, while cloud shadows were defined by cloud projection intersection with low-reflectance pixels of near-infrared (NIRO band (Google, 2022). Then, similar to Sentinel-1 imagery, Sentinel-2 imagery was composited by taking a median of all cloud and cloud shadow-masked images at the resolution of 20 m. Sentinel-2 imagery was further used to derive normalized difference spectral indices (NDSIs) that previously showed to drive biomass estimation in crops. NDSIs were mainly calculated to overcome calibration issues of individual spectral bands associated with atmospheric, illumination, and topographic conditions, thus making them more consistent for a large area analysis. In total, 45 Sentinel-2 derived NDSIs were calculated in succession from Blue (B) to shortwave infrared (SWIR2) spectral bands (Table 1):

$${NDSI}_{S {B}_{i} , {SB}_{j}} = \frac{( S {B}_{i} - S {B}_{j} )}{( S {B}_{i} + S {B}_{j} )} ,$$

where SB is the spectral band, and i and j denote its wavelengths (nm). For clarity, NDSIs in this document are referred to as a combination of band names in Table 1 (e.g., NDSI_{R,NIR1}, which is an inverted version of the normalized difference vegetation index (NDVI)).

In a further embodiment and in addition to Sentinel-1 and Sentinel-2 satellite imagery, EO data consisted of digital elevation model (DEM) and land cover data, which were also available in the Google Earth Engine catalog. Global GLO-30 DEM tiles at a native resolution of 30 m were mosaicked and resampled using bilinear interpolation to 20 m to match the resolutions of Sentinel-1 and Sentinel-2 imagery, thus creating a seamless DEM for Australia and the United States. GLO-30 DEM was derived from the WorldDEM product acquired between 2011-2015, which was locally infilled using multiple satellite imagery-derived products. DEM was further used to calculate the aspect and slope of the terrain. Similarly, the WorldCover land cover product at a native resolution of 10 m was also resampled to 20 m using mode interpolation to match the rest of the EO datasets. This product contained 11 land cover types (FIG. 6B) and was generated by ESA using supervised machine learning of Sentinel-1 and Sentinel-2 imagery collected in 2020. Finally, all the EO 300 km×300 km composites were mosaicked and clipped to the extent of Australia and the United States.

Similarly, global WorldCover land cover tiles at a native resolution of 10 m available in the Google Earth Engine catalog were also resampled to 20 m to match the rest of the spatial layers. This product contained 11 land cover types (FIG. 5) and was generated by ESA using machine learning on Sentinel-1 and Sentinel-2 imagery collected in 2020.

As described above, the prediction model device can use different possible predictor variables to generate the AGBD prediction model. In one embodiment, As GEDI measurements were averaged within 100 m×100 m and 200 m×200 m cells, it was intuitive to use these cells for aggregating EO datasets, thus forming a data input for machine learning analysis. It is a common procedure in object-based remote sensing to calculate summary statistics for objects of interest to highlight their spectral, geometrical, and spatial properties. Therefore, predictor variables in this study were calculated from Sentinel-1, Sentinel-2, and DEM mosaics by extracting summary statistics for each 100 m×100 m (e.g., 25 pixels at 20 m resolution) and 200 m×200 m (e.g., 100 pixels at 20 m resolution) GEDI cells. In total, seven statistics were calculated summarizing all pixels within each GEDI cell: average (avg), standard deviation (std), 2nd percentile (p2), 25th percentile (p25), 50th percentile (p50), 75th percentile (p75) and 98th percentile (p98). The 2nd and 98th percentiles were used as proxies for minimum and maximum values to minimize the effect of outliers in the data. As opposed to other EO mosaics, the land cover (LC) that formed the majority (maj) of each 100 m×100 m and 200 m×200 m GEDI cell was used as a predictor (e.g., LC^{maj}). For clarity, the predictor variables in this document are denoted as a combination of the name of the summary statistics and EO data used for their calculation (e.g., NDSI_{R,NIR1}^{avg} corresponds to the average of all pixel values within a GEDI cell of NDSI_{R,NIR1}). In total, 358 predictor variables were generated: 21 were extracted from three Sentinel-1 derivatives (e.g., VV, VH, and VV/VH), 315 were extracted from 45 Sentinel-2 derived NDSIs, 21 were extracted from three DEM derivatives (e.g., DEM, ASPECT, SLOPE), and final predictor was extracted from the land cover (LC).

In one embodiment, the Light Gradient Boosting Machine (LightGBM) implementation of the gradient boosting algorithm was used. Multiple LightGBM models were built to calculate potential improvements in model performance when combining satellite imagery with elevation and land cover data and to explore the necessity of using all predictors for estimating AGBD. These included: (1) Sentinel-2 and land cover data (S2+LC data), (2) Sentinel-1, Sentinel-2, DEM, and land cover data (S1+S2+DEM+LC data), and (3) top 15% of most important Sentinel-1, Sentinel-2, DEM and land cover derived predictors (top S1+S2+DEM+LC data). While in one embodiment, LightGBM is used as the ML model, in alternate embodiments, another type of ML model can be used (e.g., Neural networks, Support vector machines, and/or another type of ML model).

The data consisting of up to 263,699 GEDI cells in Australia and up to 807,775 GEDI cells in the United States were divided into ‘train’ (80%) and a hold-out ‘test’ (20%) datasets. This was done in a stratified manner by binning AGBD values into four 25th-percentile bins. Bayesian optimization with a 5-fold cross-validation (see Appendix below for the list of hyperparameters) was used to select hyperparameters that yielded the most accurate LightGBM model in terms of the lowest quantile loss at the 50th percentile (e.g., mean absolute error). Within the 5-fold cross-validation ‘train’ dataset was further divided into training (80%) and validation (20%) datasets also stratified according to the AGBD values. The main advantage of the Bayesian hyperparameter optimization is that it considers past hyperparameter evaluations when choosing the hyperparameter set for the next assessment, thus minimizing the optimization runtime. Quantile loss was used to estimate the uncertainty of AGBD estimates by calculating a 95% prediction interval (e.g., the difference between quantile loss estimates at the 2.5th percentile and 97.5^{th} percentile). Assuming that the error distribution was Gaussian, 95% prediction interval was approximately within ±2 standard deviations (SD), and 68% prediction interval was approximately within ±1 SD of the AGBD estimates. Bayesian hyperparameter optimization was limited to a runtime of 30 minutes, which was sufficient to evaluate from 3 to 1859 model configurations on a 32-core machine depending on the number of predictor variables and AGBD measurements used. According to the average 5-fold cross-validation quantile loss at the 50th percentile, the most accurate model was further evaluated using a ‘test’ dataset. To fully leverage the training data, final models for inference (e.g., to generate per-pixel AGBD and its uncertainty maps for Australia and the United States) were trained on all data using optimized hyperparameters (FIG. 6A).

The distribution of GEDI-derived AGBD values was right-skewed and ranged between 6.3 and 1970.9 Mg/ha in Australia, and 6.1 and 1978.3 Mg/ha in the United States, which posed an imbalance problem for the LightGBM regressor. Therefore, prior to the machine learning analysis, AGBD values were transformed to the normal distribution using a square root transformation. LightGBM can also have a bias in regression (e.g., overestimating low values and underestimating high values); thus, a simple linear regression (SLR) was used to reduce it. First, an SLR was fit with the measured and estimated AGBD values on the ‘train’ dataset, and then the estimated values were updated using an SLR model on the ‘test’ dataset.

As mentioned before, the accuracy of the LightGBM models for estimating AGBD was evaluated using a quantile loss at the training stage. In addition, the coefficient of determination (R²), root-mean-square error (RMSE), and relative root-mean-square error (RMSE %) were additionally calculated to evaluate final models on the ‘test’ dataset. RMSE and RMSE % were calculated as:

$$R M S E = \sqrt{\frac{1}{N} {\sum }_{i = 1}^{N} {( {x}_{i} - {\hat{x}}_{i} )}^{2}} \qquad ( 1 )$$

$$R M S E \% = \frac{R M S E}{\overline{x}} \times 100 \qquad ( 2 )$$

where xᵢ is the measured AGBD value, \hat{x}ᵢ is the estimated AGBD value, n is the total number of AGBD measurements, and x̅ is the mean of the measured AGBD values.

In one embodiment, a procedure for predictor selection was introduced to decrease the computational cost of model training and potentially improve the accuracy of the LightGBM models by reducing the number of input predictors. In one embodiment, the SHapley Additive exPlanations (SHAP) method was used to identify the most important predictors. SHAP is a game-theoretic approach that relies on shapley values to explain predictions of machine learning models. The importance of predictors is calculated by comparing the model's performance with and without a predictor for every combination of predictors. The results of the SHAP analysis were used to train additional LightGBM models using only 15% (e.g., 54 out of 358) of the most important predictors (e.g., with the highest absolute shapley values) corresponding to the top S1+S2+DEM+LC data.

In a further embodiment, a total of 36 LightGBM models were trained and optimized for estimating AGBD using predictors extracted from (1) S2+LC data (e.g., Sentinel-2 and land cover data), (2) S1+S2+DEM+LC data (e.g., Sentinel-1, Sentinel-2, DEM and land cover data) and (3) top S1+S2+DEM+LC data (e.g., S1+S2+DEM+LC data reduced to the top 15% most important predictors). This was done at different GEDI cell sizes (e.g., 100 m×100 m and 200 m×200 m) containing a different number of GEDI measurements (e.g., ≥4, ≥5, and >6 for GEDI cell sizes of 100 m×100 m and >6, ≥7 and >8 for GEDI cell sizes of 200 m×200 m) and for the two countries. In addition, 48 LightGBM models were trained and optimized using the S1+S2+DEM+LC data for four individual land covers (e.g., trees (forested lands), shrublands, grasslands, and croplands) to evaluate model performance for different vegetation types. This was necessary for understanding the reliability of the proposed methodology in areas for which GEDI L4A data was primarily calibrated (e.g., trees) and areas with limited (e.g., shrublands) and unavailable (e.g., grasslands and croplands) calibration. Thus, models trained on the top S1+S2+DEM+LC data using GEDI cell size of 100 m×100 m and containing ≥5 GEDI measurements were used for generating per-pixel maps of AGBD and its uncertainty across Australia and the United States. The final workflow for generating AGBD and its per-pixel uncertainty can be seen in FIG. 6B.

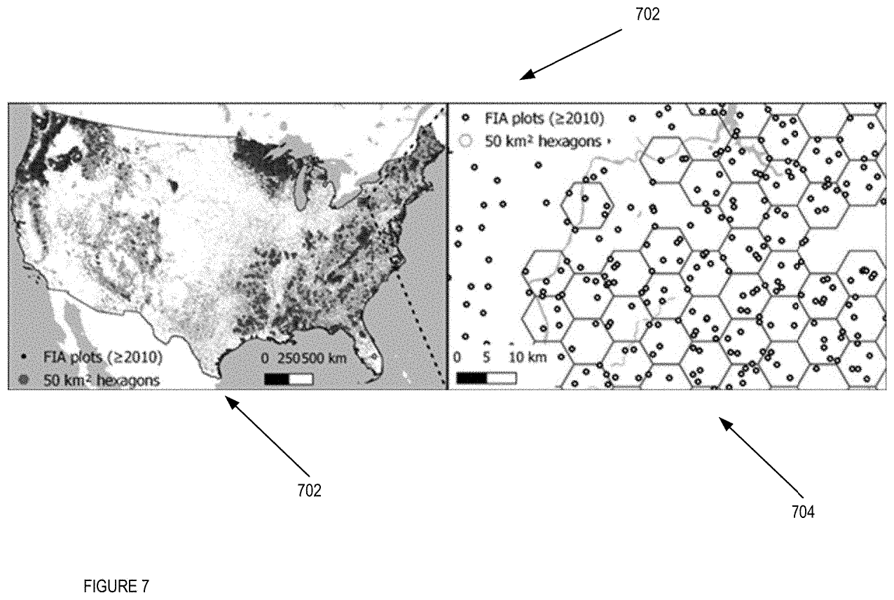

The data from the Forest Inventory and Analysis (FIA) Program of the US Forest Service were used to evaluate the accuracy of the AGBD maps and compare them to the existing products. FIA's national network contains more than 500,000 field plots distributed using stratified random sampling across forests (e.g., ≥4000 m² in size and ≥10% canopy cover) of the United States. Each plot contains four subplots of ˜7.3 m in radius (e.g., area of ˜168.1 m²) where all trees with DBH≥0.13 m were measured. In one embodiment, AGBD for each FIA plot was calculated using a Component Ratio Method in rFIA package. To reduce the temporal gap between remote sensing derived AGBD maps and FIA measurements, FIA data were only limited to plots that were measured after 2010 (e.g., 140,981 plots). Due to geolocation inaccuracies (e.g., some plot locations were randomly displaced up to 1 km from their true locations) of FIA data, the direct evaluation of AGBD maps using FIA plots was impractical. Therefore, FIA plots were further aggregated by calculating the average AGBD within 50 km² hexagons that contained at least 4 FIA plots following the minimum number of plots used by FIA to define its strata for estimation. Furthermore, only 50 km² hexagons where a samples size of ≥4 FIA plots resulted in a relative standard error (RSE)≤25% (assuming simple random sampling) of the mean AGBD estimate produced in this study within each hexagon were selected for further analysis using sgsR package. A relatively fine scale of 50 km² for FIA plot aggregation was chosen to highlight potential AGBD saturation issues in high biomass areas that would be otherwise diluted at coarser resolutions, while the RSE≤25% threshold allowed the use of only homogeneous plots for validation. In this way, 4,051 aggregated 50 km² hexagon plots that contained 4-10 FIA plots were generated to validate AGBD maps (FIG. 7, blocks 702 and 704). FIG. 7 is an illustration of one embodiment of AGBD map 700 illustrating a FIA plot of AGBD data, with the location of 140,981 FIA plots and 4,051 FIA-derived 50 km² hexagon plots across the United States (702), and a zoom-in area showing the aggregation procedure for generating FIA-derived 50 km² hexagon plots (704).

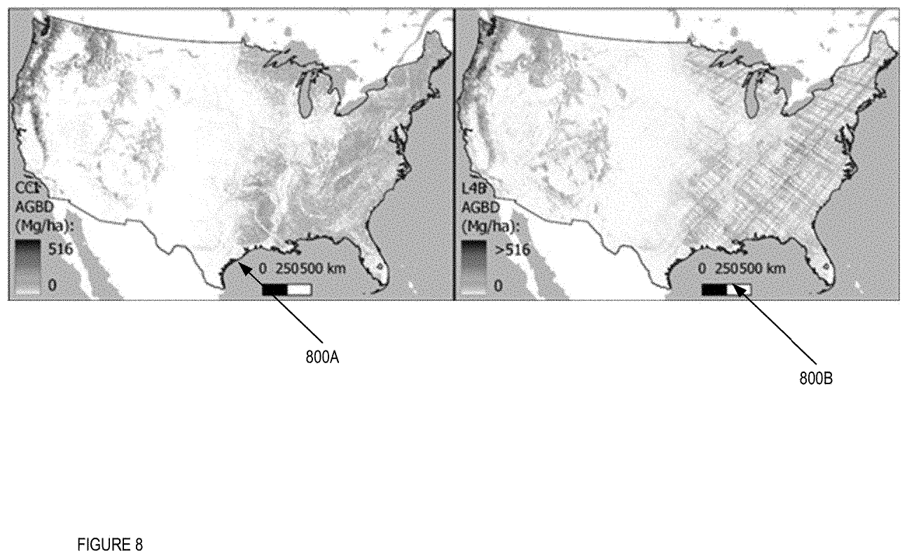

For comparisons, the most recent available for download global AGBD product developed by CCI for 2018 at 100 m resolution (FIG. 8, block 800A) as well as GEDI L4B product for 2019-2021 at 1 km resolution were used (FIG. 8, block 800A), FIG. 8 is an illustration of third-party AGBD maps 800A-B. The CCI product was derived using the BIOMASAR algorithm that inverts a semi-empirical model relating the forest backscatter from SAR C-band Sentinel-1 and L-band ALOS-2 PALSAR-2 to global estimates of AGBD. In contrast, GEDI L4B product was produced by aggregating filtered GEDI L4A data between 18 Apr. 2019 to 4 Aug. 2021 within 1 km×1 km cells. All three AGBD maps (CCI, L4B, and the one produced in this study) were evaluated using 4,051 FIA-derived plots. To ensure a fair comparison, the AGBD map produced in this study was clipped to the same extent as the CCI product (e.g., all land covers except forests according to the Copernicus Global Land service land cover datasets were masked out) and L4B product (e.g., 1 km×1 km cells without AGBD estimates due to incomplete spatial coverage as the result of persistent clouds in some areas and the orbital dynamics of the ISS were also masked out) within the United States.

In one embodiment, while a biomass library containing nearly 11,000 field-measured plots also exists for Australia, it was unsuitable for validating AGBD maps in this study due to inconsistencies in its sampling design and as some of its data were used for calibrating both CCI and GEDI-derived AGBD products.

The analysis based on the S2+LC data resulted in AGBD estimated with R2 of 0.61-0.71, RMSE of 59-86 Mg/ha, and RMSE % of 45-83%. However, model performance improved with the addition of Sentinel-1 and DEM predictors (e.g., S1+S2+DEM+LC data): AGBD estimation with R² of 0.66-0.74, RMSE of 55-81 Mg/ha, and RMSE % of 41-77%. Furthermore, model performance deteriorated only marginally when using the top S1+S2+DEM+LC data: AGBD estimation with R² of 0.65-0.73, RMSE of 56-81 Mg/ha, and RMSE % of 42-79% (Table 2).

After calculating the number of occurrences of the top 15% most important predictors (according to the SHAP approach) across all models, it was found that Sentinel-2 derived NDSIs using Green, Red Edge, NIR, and SWIR bands (e.g., NDSI_{NIR1,NIR2}^{std}, NDSI_{RE3,NIR1}^{std}, NDSI_{SWIR1,SWIR2}^{p75}, NDSI_{G,NIR2}^{p50}, NDSI_{G,NIR1}^{p25}, NDSI_{SWIR1,SWIR2}^{p25}, NDSI_{G,NIR2}^{avg}, and NDSI_{SWIR1,SWIR2}^{avg}), DEM-derived slope (SLOPE^{std}, SLOPE^{p98}, SLOPE^{p75}, SLOPE^{p50}, SLOPE^{avg}, and SLOPE^{p25}), land cover (e.g., LC^{maj}) and Sentinel-1 derived VV/VH ratio (S1_{VV/VH}^{p25}) were the most important in estimating AGBD.

TABLE 2
AGBD estimation accuracy based on the ‘test’ dataset (e.g., 20% of the total GEDI cells).

| | | | | S1 + S2 + DEM + LC | | | Top S1 + S2 + DEM + LC | | | S2 + LC | | |
|---|---|---|---|---|---|---|---|---|---|---|---|---|
| | | GEDI | | data (358 predictors) | | | data (54 predictors) | | | data (316 predictors) | | |
| | Resolution | | ‘test’ | | RMSE | RMSE | | RMSE | RMSE | | RMSE | RMSE |
| Country | (m) | measurements | cells | R² | (Mg/ha) | % | R² | (Mg/ha) | % | R² | (Mg/ha) | % |
| United States | 100 | ≥4 | 97,887 | 0.68 | 69.5 | 50 | 0.66 | 71.3 | 52 | 0.63 | 75.3 | 55 |
| United States | 100 | ≥5 | 20,274 | 0.7 | 68.7 | 48 | 0.68 | 71.1 | 50 | 0.64 | 74.8 | 52 |
| United States | 100 | ≥6 | 5,054 | 0.66 | 80.6 | 52 | 0.65 | 81.0 | 53 | 0.61 | 86.3 | 56 |
| United States | 200 | ≥6 | 161,465 | 0.72 | 59.3 | 43 | 0.71 | 60.2 | 44 | 0.68 | 64.2 | 47 |
| United States | 200 | ≥7 | 93,531 | 0.73 | 59.0 | 42 | 0.72 | 60.2 | 43 | 0.69 | 64.1 | 46 |
| United States | 200 | ≥8 | 50,482 | 0.74 | 58.6 | 41 | 0.72 | 60.3 | 42 | 0.69 | 63.9 | 45 |
| Australia | 100 | ≥4 | 35,098 | 0.71 | 58.0 | 77 | 0.69 | 59.8 | 79 | 0.66 | 62.4 | 83 |
| Australia | 100 | ≥5 | 6,762 | 0.69 | 61.2 | 77 | 0.68 | 62.3 | 78 | 0.65 | 65.6 | 82 |
| Australia | 100 | ≥6 | 1,215 | 0.71 | 59.7 | 71 | 0.72 | 58.7 | 70 | 0.69 | 61.3 | 73 |
| Australia | 200 | ≥6 | 52,732 | 0.74 | 54.9 | 69 | 0.73 | 56.4 | 71 | 0.71 | 58.5 | 74 |
| Australia | 200 | ≥7 | 29,978 | 0.74 | 55.6 | 70 | 0.72 | 57.0 | 71 | 0.7 | 59.1 | 74 |
| Australia | 200 | ≥8 | 15,450 | 0.73 | 57.1 | 70 | 0.72 | 58.8 | 72 | 0.69 | 61.2 | 75 |

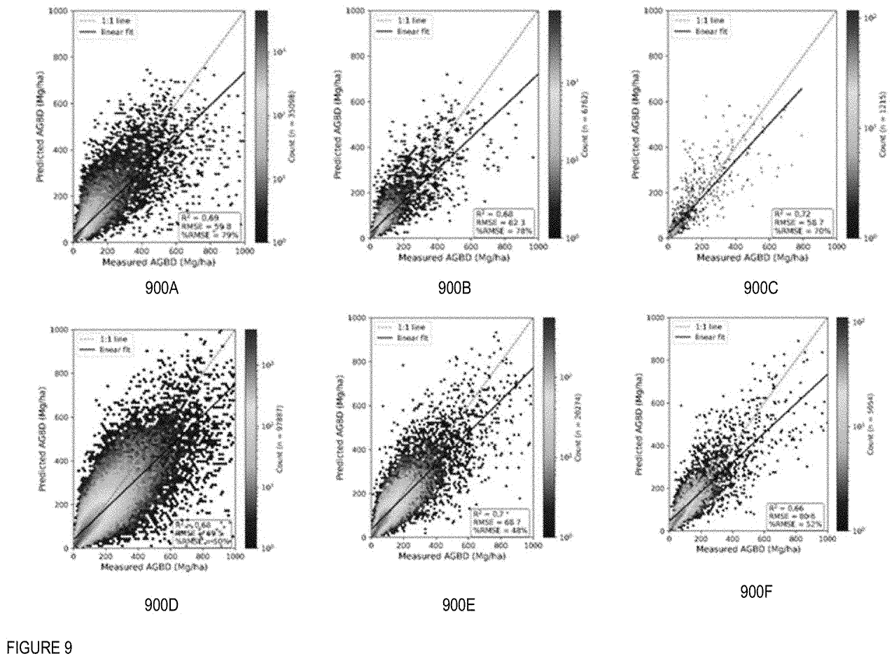

In Table 2, the AGBD estimation at fine resolution (e.g., 100 m) came at the cost of accuracy. AGBD prediction models at 200 m resolution generally outperformed the models trained at 100 m resolution with an R² improvement of 0.02-0.08 and RMSE and RMSE % reduction of 1-22 Mg/ha and 1-11%, respectively. Furthermore, there was no substantial performance difference between models trained using different GEDI measurement thresholds (e.g., ≥4, ≥5, ≥6 for 100 m×100 m GEDI cells (FIG. 8) and ≥6, ≥7, ≥8 for 200 m×200 m GEDI cells). Overall, this resulted in model performance differences of R² of ≤0.04, RMSE of ≤12 Mg/ha, and RMSE % of ≤6%. Furthermore, it is noted that bias correction using SLR improves the accuracy of the models in terms of R² by ≤0.03, RMSE by ≤1.5 Mg/ha, and RMSE % by ≤2%. However, it could be seen in FIG. 9 that even after bias correction using SLR, there can be a visible overestimation of low AGBD values and underestimation of high values, while prediction errors increased with AGBD estimates (e.g., errors were heteroscedastic and proportional to the estimate). FIG. 9 is an illustration of one embodiment of a series of plots 900A-F for determining the most important predictor variables. In one embodiment, in FIG. 9, the ability of models based on the top S1+S2+DEM+LC data to estimate AGBD at 100 m resolution on the ‘test’ dataset (e.g., 20% of the total GEDI cells) in Australia 900A-C and the United States 900D-F using ≥4 (900A or 900D), ≥5 (900B or 900E), and ≥6 (900C or 900F) GEDI measurements per GEDI cell.

According to the LightGBM modeling performed for the individual land cover types (Table 3), the models for AGBD estimation of trees trained on the S1+S2+DEM+LC data performed similarly to the models for AGBD estimation of all land cover types (R² of 0.66-0.77, RMSE of 53-75 Mg/ha and RMSE % of 38-66%). However, the accuracy dropped significantly for models estimating the AGBD of shrublands (R² 0.32-0.52, RMSE of 6-19 Mg/ha and RMSE % of 39-65%), grasslands (R² 0.39-0.57, RMSE of 12-25 Mg/ha and RMSE % of 46-62%) and croplands (R² of 0.14-0.68, RMSE of 20-38 Mg/ha and RMSE % of 43-85%) (Table 3).

TABLE 3
AGBD estimation accuracy based on the ‘test’ dataset (e.g., 20% of the total GEDI cells)
of individual land cover types.

| | | | Trees | | | | Shrublands | | | |
|---|---|---|---|---|---|---|---|---|---|---|
| | Resolution | GEDI | ‘test’ | | RMSE | RMSE | ‘test’ | | RMSE | RMSE |
| Country | (m) | measurements | GEDI cells | R² | (Mg/ha) | % | GEDI cells | R² | (Mg/ha) | % |
| United States | 100 | ≥4 | 86,009 | 0.66 | 70.8 | 47 | 3,917 | 0.35 | 19.4 | 65 |
| United States | 100 | ≥5 | 18,167 | 0.67 | 70.8 | 46 | 792 | 0.34 | 18.7 | 63 |
| United States | 100 | ≥6 | 4,594 | 0.66 | 74.8 | 46 | 172 | 0.32 | 17.9 | 60 |
| United States | 200 | ≥6 | 143,339 | 0.72 | 60.1 | 40 | 5,736 | 0.42 | 17.9 | 57 |
| United States | 200 | ≥7 | 84,502 | 0.72 | 59.5 | 39 | 3,039 | 0.39 | 17.3 | 56 |
| United States | 200 | ≥8 | 46,184 | 0.73 | 58.7 | 38 | 1,520 | 0.36 | 17.4 | 57 |
| Australia | 100 | ≥4 | 26,821 | 0.71 | 60.3 | 66 | 3,075 | 0.45 | 7.2 | 47 |
| Australia | 100 | ≥5 | 5,248 | 0.73 | 59.6 | 62 | 605 | 0.4 | 9.9 | 63 |
| Australia | 100 | ≥6 | 929 | 0.68 | 62.8 | 62 | 124 | 0.32 | 8.9 | 55 |
| Australia | 200 | ≥6 | 40,486 | 0.76 | 55.5 | 58 | 4,231 | 0.52 | 6.4 | 41 |
| Australia | 200 | ≥7 | 23,791 | 0.77 | 54.0 | 57 | 2,228 | 0.51 | 7.0 | 43 |
| Australia | 200 | ≥8 | 12,618 | 0.77 | 52.7 | 57 | 1,058 | 0.45 | 6.2 | 39 |
| | | | Grasslands | | | | Croplands | | | |
| | Resolution | GEDI | ‘test’ | | RMSE | RMSE | ‘test’ | | RMSE | RMSE |
| Country | (m) | measurements | GEDI cells | R² | (Mg/ha) | % | GEDI cells | R² | (Mg/ha) | % |
| United States | 100 | ≥4 | 7,662 | 0.42 | 23.0 | 62 | 165 | 0.59 | 25.1 | 52 |
| United States | 100 | ≥5 | 1,273 | 0.42 | 23.7 | 60 | 20 | 0.19 | 38.4 | 85 |
| United States | 100 | ≥6 | 281 | 0.41 | 24.7 | 60 | 3 | n/a | n/a | n/a |
| United States | 200 | ≥6 | 11,900 | 0.51 | 21.2 | 53 | 325 | 0.58 | 28.8 | 47 |
| United States | 200 | ≥7 | 5,799 | 0.50 | 20.7 | 52 | 118 | 0.68 | 24.9 | 43 |
| United States | 200 | ≥8 | 2,697 | 0.51 | 20.7 | 51 | 45 | 0.4 | 33.1 | 63 |
| Australia | 100 | ≥4 | 5,086 | 0.47 | 15.1 | 57 | 22 | 0.3 | 24.2 | 58 |
| Australia | 100 | ≥5 | 892 | 0.39 | 14.9 | 58 | 2 | n/a | n/a | n/a |
| Australia | 100 | ≥6 | 159 | 0.39 | 14.1 | 55 | 0 | n/a | n/a | n/a |
| Australia | 200 | ≥6 | 7,842 | 0.57 | 13.0 | 49 | 49 | 0.47 | 20.0 | 44 |
| Australia | 200 | ≥7 | 3,881 | 0.57 | 12.4 | 46 | 18 | 0.14 | 30.6 | 67 |
| Australia | 200 | ≥8 | 1,744 | 0.52 | 13.3 | 49 | 7 | n/a | n/a | n/a |

The prediction maps of AGBD at 100 m resolution for Australia and the United States in 2020 are presented in FIG. 9. The maps were generated using models trained on the top S1+S2+DEM+LC data extracted within GEDI cells with ≥5 measurements at 100 m resolution (FIG. 8, blocks 900B and 900E). The uncertainty maps of AGBD were also produced, and their estimates were generally proportional to the magnitude of the AGBD estimate.

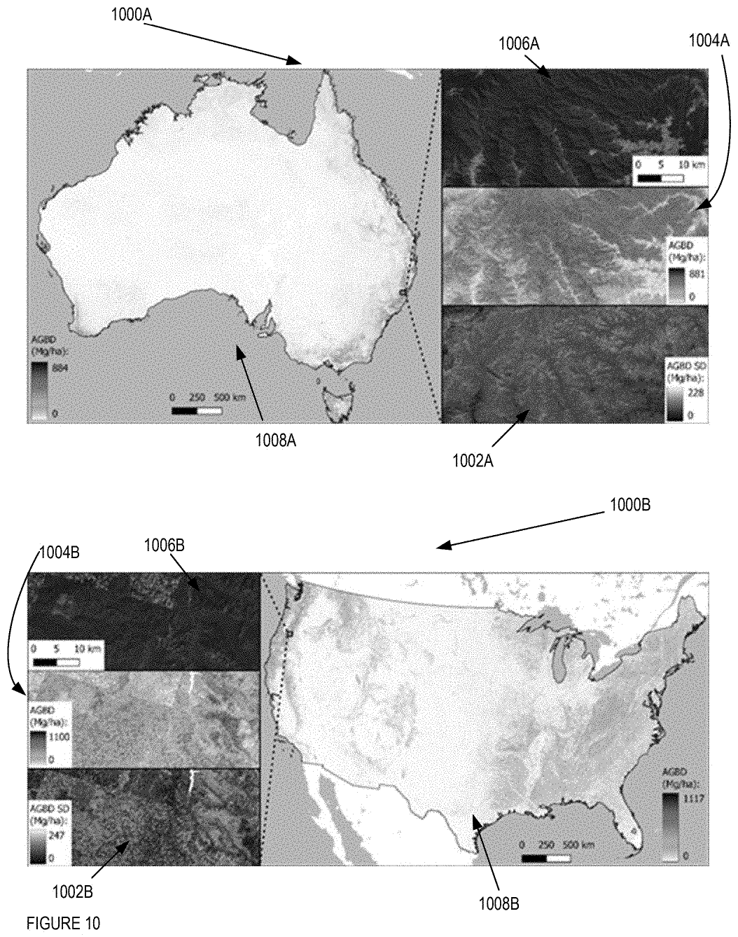

In one embodiment, using the trained machine learning models, the AGBD can be predicted for a geographic area. FIG. 10 is an illustration of one embodiment of predictor maps of AGBD 1000A-B. In FIG. 10, the AGBD maps 1000A-B include prediction maps of AGBD at 100 m resolution across Australia 1008A and the United States 1008B that were derived using the top S1+S2+DEM+LC data in 2020. In addition, in FIG. 10, the zoom-in areas show a satellite image (1006A-B), AGBD (1004A-B), and ±1 SD of AGBD (1002A-B).

According to FIG. 10, in the United States, the highest levels of AGBD occurred in the coniferous forests of the northwest, while the lowest values occurred in the country's interior, in areas dominated by desert and semi-arid climates. In Australia, the highest AGBD was in the eucalypt forests of the southeast, while the lowest values, similar to the United States, occurred in the central parts of the country, also dominated by desert and semi-arid climates (FIG. 1008A). In Australia, AGBD estimates ranged up to 884.2 Mg/ha with a mean of 24.6 Mg/ha, while AGBD uncertainty (e.g., SD) ranged up to 484.8 Mg/ha with a mean of 7.7 Mg/ha. Similarly, in the United States AGBD estimates ranged up to 1116.8 Mg/ha with a mean of 62.8 Mg/ha, while AGBD uncertainty ranged up to 360.4 Mg/ha with a mean of 30.1 Mg/ha. Importantly, AGBD uncertainty was on average only 42.2% and 43.0% of the estimated AGBD in Australia and the United States, respectively.

Total AGB stocks of vegetated areas (e.g., forests, mangroves, shrublands, grasslands, and croplands) in Australia were equal to 17.7 Pg (a mean of 24.6 Mg/ha), while in the United States they were equal to 44.1 Pg (a mean of 62.8 Mg/ha). However, total AGB stocks of only forested lands (e.g., trees and mangroves) in Australia were substantially lower, equal to 9.8 Pg (a mean of 70.6 Mg/ha), while in the United States they amounted to 37.1 Pg (a mean of 132.1 Mg/ha). These total AGB estimates were then compared with those from the CCI and GEDI L4B products. According to the CCI AGBD map representing forested lands only, Australia's total AGB stocks were equal to 9.2 Pg (a mean of 80.0 Mg/ha), while in the United States they were equal to 32.7 Pg (a mean of 102.0 Mg/ha). In contrast, the calculation of total AGB stocks using GEDI L4B product was challenging due to the orbital dynamics of the ISS leading to 9.1% and 17.1% of 1 km×1 km AGBD cells missing from this dataset in Australia and the United States, respectively. However, based on the mean estimates of AGBD of forested lands and their area GEDI L4B total AGB stocks were previously estimated to be 12.1 Pg (a mean of 15.7 Mg/ha) and 42.7 Pg (a mean of 54.7 Mg/ha) in Australia and the United States, respectively.

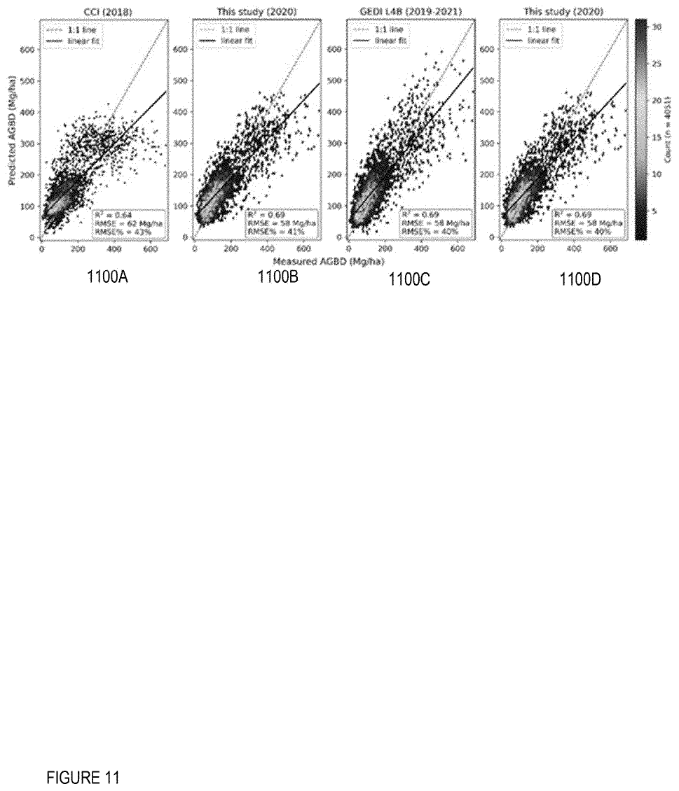

The validation of the AGBD map for 2020 against the one from CCI for 2018 and GEDI L4B for 2019-2021 using 4,051 FIA-derived 50 km² hexagon plots in the United States is presented in FIG. 11. FIG. 11 is an illustration of one embodiment of a validation of a CCI AGBD map 1100A-D. The AGBD map produced in this study outperformed the CCI product in terms of all accuracy metrics (e.g., R² increase of 0.05, RMSE decrease of 4 Mg/ha, and RMSE % decrease of 2%) (1100A-B). Both maps saturated in regions of high AGBD. However, this was much more prominent in the CCI map, where saturation started in areas with an AGBD of only >300 Mg/ha. In contrast, the AGBD map produced in this study performed on par with the GEDI L4B product for 2019-2021 (e.g., R² of 0.69, RMSE of 58 Mg/ha, and RMSE % of 40%) (1100C-D).

The methodology developed can be used to inform forest management decisions and facilitate carbon budget accounting, such as accurate AGBD estimation using the proposed modeling framework is feasible at multiple spatial and temporal scales. The models estimated AGBD with R² of 0.68-0.74, RMSE of 55-81 Mg/ha, and RMSE % of 42-77% in Australia and the United States in 2020. The proposed modeling framework could be used for generating annual wall-to-wall maps of AGBD in other regions (and potentially globally) at a resolution as fine as 100 m. While multiple AGBD estimation studies developed separate models for different plant functional or land cover types, this study demonstrated that such information could be directly incorporated as a predictor, thus minimizing model training time (by creating a single global model), while avoiding the loss of accuracy due to each model having a smaller number of samples to be trained from.

Generally, AGBD estimation models at 200 m resolution outperformed the models trained at 100 m resolution. This could be attributed to geolocation uncertainty in GEDI measurements and the edge effects of large tree crowns located at the boundaries of GEDI cells. However, further reduction of the resolution to, for example, 50 m is expected to deteriorate the estimation accuracy of AGBD as each GEDI footprint center had horizontal geolocation accuracy of ±10 only. This would also result in the reduction of valid GEDI measurements per cell, which, surprisingly, did not lead to a substantial accuracy loss in this study (Tables 3 and 4). In contrast, a further increase of the resolution to, for example, 500 m will most likely improve the estimation accuracy of AGBD, as the effects of geolocation uncertainty and edge effects will be largely diluted at such a scale.

The use of GEDI measurements aggregated within pre-defined cells potentially introduced uncertainties due to the landscape heterogeneity inside the cells. However, the alternative of matching GEDI measurements with the EO data directly would likely lead to even higher uncertainties. Similarly, the calculation of median composites of Sentinel-1 and Sentinel-2 imagery could be considered overly simplistic, resulting in the loss of information necessary to improve the accuracy of AGBD estimation. Therefore, future studies should explore extracting temporal predictors from Sentinel-1 and Sentinel-2 imagery, for example, monthly or seasonal medians, or fitting double logistic or harmonic regressions to EO data. As opposed to the median, the mean compositing can result in pixels containing values that were not part of the original imagery, while maximum and minimum compositing reflects non-typical appearance of the landscape, and in case of Sentinel-2 imagery can result in pixels contaminated by clouds and cloud shadows due to their high and low reflectance, respectively. However, instead of generating median composites from EO data, a better approach would be calculating geomedians, which maintain the relationship between spectral bands. Finally, LightGBM models could be equipped with the ability to learn temporal or geographical priors, by feeding them with EO data timestamps and geographical coordinates (in a suitable cyclic encoding) as additional predictors All of this should improve the performance of models, especially in areas prone to disturbances in short periods of time (e.g., croplands and grasslands). Moreover, the addition of proprietary satellite L-band SAR imagery (e.g., ALOS-2 PALSAR-2 or SAOCOM 1A and 1B) that is known to saturate less than C-band SAR imagery (e.g., Sentinel-1) when estimating biomass could improve the performance of the models even further. Finally, an alternative approach using sparse supervision of CNNs should be able to produce more highly resolved AGBD estimates. However, this will likely come at the expense of accuracy and substantial loss in model training and inference speeds.

The models for estimating the AGBD of trees (e.g., forested lands) outperformed the ones for estimating AGBD in shrublands, grasslands, and croplands (Table 3) (Note: the accuracy metrics calculated for AGBD estimation in croplands should be interpreted with caution due to a relatively small ‘test’ dataset of ≤325 GEDI cells). This was expected as GEDI data was mainly calibrated in forested areas in Oceania and North America (2,619 training samples) with limited calibration in grasslands and woodlands (83 training samples) and no calibration in croplands. Grasslands and croplands are also prone to disturbances in short periods of time (e.g., due to harvesting, bushfires, etc.), which was not captured in annual median composites of Sentinel-1 and Sentinel-2 imagery. Furthermore, GEDI filtering based on RSE in GEDI-derived AGBD exceeding 50% in this study resulted in the removal of all AGBD measurements <6 Mg/ha, which were mainly associated with shrublands, grasslands, and croplands. This further highlights the unreliability of GEDI measurements across these land covers, and potentially led to AGBD overestimation in areas of low biomass (<6 Mg/ha) in this study. Interestingly, Grassland, Shrub and Woodland (GSW) model of GEDI Level 4A product showed the highest accuracy among all plant functional types (R² of 0.86 and RMSE % of 55.4%). However, EO data were not able to exploit the high accuracy of the GSW model, with shrubland and grassland models achieving R² of only 0.32-0.57 and RMSE % of 39-65% in this study (Table 3). This could be partly related to the unrepresentativeness of the GSW model as well as potential noise in the EO data as, for example, bare ground and water pixels were not masked out when calculating summary statistics within 100 m×100 m and 200 m×200 m GEDI cells.

In one embodiment, AGBD estimates were mainly driven by predictors extracted from Sentinel-2 derived NDSIs using Green, Red Edge, NIR, and SWIR bands, elevation-derived slope, land cover, and Sentinel-1 derived VV/VH ratio. Similar NDSIs have previously been shown to be important in estimating crop yields, while terrain slope was also reported to be correlated with AGBD. However, the importance of the DEM-derived slope could be partly an artifact of the GEDI algorithm leading to height estimation errors over slopes in the Level 2A product, leading to subsequent overestimation of AGBD in such areas. In this study GEDI measurements on slopes >30° were removed as they previously showed to adversely affect accurate retrieval of both terrain and tree heights. However, AGBD maps produced in this study were still positively correlated with areas of moderate slopes (>15° and <30°). Therefore, more conservative filtering of GEDI measurements based on the slope steepness (e.g., >15°) could further improve the models' performance. It is also important to note that SHAP is only one way of identifying the predictor importance of machine learning models (albeit one of the most stable ones). Different methods (e.g., permutation or gain methods) or the use of SHAP after removing correlated predictor variables could result in the most important predictors being rather different.

Even after data filtering based on Level 4A product quality and degraded state of positioning flags as well as relative standard errors of AGBD, there were still a lot of erroneous GEDI measurements (e.g., high AGBD estimates in areas of moderate slopes (>15° and ≤30°) as well as in barren and sparse vegetation areas, etc.). It was previously reported that GEDI Level 4A (Version 2.1) orbit granules were affected by low cloud/fog, which was not addressed in this study. Some of these erroneous measurements were removed based on land cover filtering prior to averaging AGBD within GEDI cells. However, it can be difficult to identify erroneous GEDI measurements in full based on the information provided in GEDI Level 4A (Version 2.1) data, which inadvertently reduced the accuracy of models in this study. With further revisions and calibration of the GEDI Level 4A product as well as additional filtering using outlier detection algorithms, an improved accuracy of the AGBD estimation using the proposed machine learning method is expected. Further filtering of GEDI measurements to only include high-power beams (e.g., ‘BEAM0101’, ‘BEAM0110’, ‘BEAM1000’, and ‘BEAM1011’) collected at night (e.g., ‘solar_elevation’<0) to ensure penetration of canopies of >95% canopy cover and avoid the negative impact of background solar illumination on GEDI waveforms could also improve model performance.

In one embodiment, the prediction model device can be potentially used to assess annual or seasonal AGBD changes. However, this can be done with caution as per-pixel uncertainty of AGBD estimates can be substantially higher than seasonal or annual change in biomass due to forest growth or disturbance (e.g., logging or bushfires). For example, in Australia, the average growth rate of forests ranges between 0.5-12.9 Mg/ha/year, while the AGBD uncertainty (e.g., AGBD SD) estimated in this study across Australia ranged up to 484.8 Mg/ha/year with a mean of 7.7 Mg/ha/year (e.g., 42.2% of the estimated AGBD). Therefore, the per-pixel uncertainty of AGBD maps can be used to understand the reliability of the estimates. Model training for monitoring seasonal AGBD changes is also complicated by the fact that GEDI-derived AGBD within cells could vary on average by 30-38 Mg/ha from season to season within the same year (this is based on the estimates of intersecting GEDI 100 m×100 m cells containing ≥3 GEDI measurements in 2020). Furthermore, In one embodiment, the errors of GEDI measurements were not propagated to per-pixel AGBD uncertainty. If errors from GEDI measurements (due to modeling errors, allometries, geolocation, etc.) were to be considered, then the per-pixel uncertainty of AGBD would be either much larger due to error accumulation or lower due to error cancellation. It was reported that GEDI Level 4A product has an uncertainty (e.g., RMSE %) of 28.7-79.0% depending on the geographic region and plant functional type.

The main advantages of the proposed method for AGBD estimation could be deduced when compared to previous AGBD products (e.g., CCI for 2018 and GEDI L4B for 2019-2021). First, the proposed method generated a product with overall higher accuracy and a visibly lower level of saturation in areas with high AGBD (e.g., >300 Mg/ha) as compared to the CCI product (FIGS. 10A and 10B). The proposed method potentially mitigated the saturation in high biomass areas by exploiting a large variety (up to 358) of EO-derived predictors. Second, the proposed method performed on par with the GEDI L4B product (FIGS. 10C and 10D), while offering AGBD maps at a much higher resolution (100 m vs 1 km). While it is clear that the GEDI L4B product exhibited limited saturation in high biomass areas, the method proposed in this study could effectively fill its current observation gaps and increase its spatial resolution while maintaining accuracy. In addition, while the validation using FIA-derived 50 km² hexagons was applicable to forested lands only, it was off the AGBD mapping resolution of 100 m and 200 m in this study. Finer resolution validation sets for forested lands as well as croplands, grasslands, and shrublands in both Australia and the United States are needed to fully understand the accuracy of the proposed method. Third, the proposed method solely relies on open access EO data that could be readily accessed in the Google Earth Engine catalog. While, for example, the CCI product for 2018 relies on freely distributed annual ALOS-2 PALSAR-2 mosaics, its application at different temporal or spatial resolutions would require a substantial investment to purchase additional satellite imagery. Fourth, the method proposed in this study offers a straightforward way to estimate AGBD uncertainty using a quantile loss, and it could be easily modified to derive AGBD at different spatial and temporal resolutions. Finally, comparisons of total AGB stocks of forested lands showed the method proposed in this study estimated more AGB for both countries as compared to the CCI product (9.8 Pg vs 9.2 Pg in Australia, and 37.1 Pg vs 32.7 Pg in the United States). However, the predictions of this study were lower than that of the GEDI L4B product, which estimated total AGB stocks at 12.1 Pg and 42.7 Pg in Australia and the United States, respectively. These differences are likely related, in part, to models' accuracy, different degrees of saturation in high biomass areas, and disagreement in the extent of forested lands between all three products.

As mentioned above, the prediction model device can use climate data to generate the AGBD prediction model. FIG. 3B is a flow diagram of one embodiment of a process 350 to generate an AGBD prediction model for a target landmass using climate data. In one embodiment, a prediction model device is used to generate the AGBD prediction model, such as the prediction model device 102 as described in FIG. 1 above. In FIG. 3B, process 350 begins by receiving the satellite imagery data (352), DEM data (358), and climate data from a database (SILO) 364 for the target landmass. Process 350 preprocesses each of the input data. For example, process 350 preprocess the satellite imagery data by removing the clouds and clouds' shadow from the imagery data at block 354. In addition, process 350 mosaics the imagery data and normalizes the imagery data to produce Normalized Difference Spectral Index (NSDI) data, so as to produce an NSDI stack of the data for the satellite imagery data at block 356. In one embodiment, seasonal Sentinel-2 composite data was generated using a S2GM mosaicing algorithm and was further used to calculate Normalized Difference Spectral Indices (NDSIs) from the available spectral bands.

At block 358, process 350 receives digital elevation model (DEM) data, where process 350 preprocesses the DEM data to generate aspect, roughness, slope, Topographic Position Index and Terrain Ruggedness Index data (360). This elevation data is the DEM stack (362). Furthermore, process 350 receives the climate database at block 364. In one embodiment, the climate database is a Scientific Information for Land Owners (SILO) data. At block 366, process 350 preprocesses the climate data to extract average precipitation, average radiation, minimum temperature, and maximum temperature for the landmass, which leads to a climate stack (368).

In one embodiment, at block 370, process 350 performs a stacking operation that produces a merged satellite, elevation, and climate stack (372). Process 350 generates zone statistics at block 374. In one embodiment, the statistics generated are minimum, maximum, average, and standard deviation. In addition, process 350 receives LIDAR-derived AGBD data (for example, the LIDAR-derived AGBD data can be GEDI L4A data for the target landmass). In one embodiment, the LIDAR-derived AGBD data is sparse AGBD data for the target landmass as each LIDAR-derived AGBD data is specific to a small part of the landmass. This is because, in this embodiment, the LIDAR-derived AGBD data is generated from a laser on a satellite and this laser cannot cover a wide area as the laser is a very focused spot of the landmass. Thus, the LIDAR-derived AGBD data covers a small section of the landmass. In addition, process 350 can disregard the LIDAR-derived AGBD data that does not meet certain quality thresholds. For example, and in one embodiment, the LIDAR measurements not meeting the requirements of L4A product quality, and those with a degraded state of pointing or positioning information and an estimated relative standard error in GEDI-derived AGBD exceeding 50% were rejected.

Process 350 grids the landmass at block 382. In one embodiment, process 350 grids the landmass into 200 m×200 m cells. For example, and in one embodiment, process 350 creates approximately 62,000 cells for the Australian landmass. In one embodiment, for each 200 m×200 m cell, process 350 calculates the number of available GEDI measurements and builds models based on average AGBD of cells containing >5 GEDI measurements. While in one embodiment, the cell size is 200 m×200 m, in alternate embodiment, a different sized cell can be used.

At block 376, process 350 uses the LIDAR-derived AGBD data as the training data for a machine learning model that will be used as an AGBD prediction model. Process 350 uses light Gradient Boosting Machine (LightGBM) training with Bayesian Hyper parametric optimization to generate the AGBD prediction model. In one embodiment, Bayesian hyperparameter optimization was used to identify the most accurate Light Gradient Boosting Machine (LightGBM) model using 5-fold cross-validation. The analysis based on only Sentinel-2 imagery resulted in AGBD predicted with the coefficient of determination (R²) of 0.68-0.75, root-mean-square error (RMSE) of 40-46 Mg/ha and root-mean-square percentage error (RMSPE) of 47-69%. Model performance improved with the addition of DEM and climate information: AGBD prediction with R² of 0.77-0.81, RMSE of 35-40 Mg/ha and RMSPE of 41-52%. Using a SHapley Additive exPlanations (SHAP) approach to explain the output of LightGBM models it was found that Sentinel-2 derived NDSIs using Red Edge and Short-wave Infrared bands were the most important in predicting seasonal AGBD. In a further embodiment, similar model performance can be expected for annual prediction of AGBD at a finer resolution (e.g., 100 m) due to higher density of GEDI measurements. This research highlights methodological opportunities for combining GEDI measurements with satellite imagery and other environmental data toward seasonal AGBD mapping at the regional scale through data fusion. Process 350 outputs the AGBD prediction model at block 378. With the prediction model, process 350 can generate the AGBD map using the AGBD prediction model, such as a wall-to-wall AGBD of map of the targeted landmass.

In one embodiment, a machine learning approach for fusing open access GEDI, Sentinel-1, Sentinel-2, elevation, and land cover data for large area AGBD mapping is proposed. Models performed well with R² of 0.66-0.74, RMSE of 55-81 Mg/ha, and RMSE % of 41-77%. The AGBD estimation was mainly driven by Sentinel-2, and land cover-derived predictors, while their fusion with Sentinel-1 and elevation-derived predictors boosted the performance of the models (R² increase of 0.03-0.05, RMSE decrease of 4-6 Mg/ha and RMSE % decrease of 4-6%). Unsurprisingly, the AGBD prediction at fine resolution (e.g., 100 m) came at the cost of accuracy, with the most reliable predictions in forested areas. Improving AGBD estimation in shrublands, grasslands, and croplands will potentially require additional GEDI calibration in those land cover types. The proposed method solely relies on open access EO data and provides less saturation in regions of high biomass as compared to previous AGBD products. Prediction maps produced in this study could serve as a baseline for current AGB stocks of forested lands equal to 9.8 Pg and 37.1 Pg in Australia and the United States, respectively. This study also highlights methodological opportunities for combining GEDI and EO data towards annual and seasonal AGBD mapping at the global scale through data fusion. Overall, using the proposed methodology could potentially overcome the common challenges of existing EO-based methods: 1) signal saturation at high AGBD levels, 2) reliance on proprietary datasets and 3) temporal limitation to annual estimates.

### APPENDIX

In one embodiment, hyperparameters of LightGBM in regression mode were optimized using Bayesian hyperparameter optimization. Refer to LightGBM and for hyperparameter description (*Note: alpha for quantile loss was set to 0.5 (e.g., 50^{th} percentile, which corresponds to the mean absolute error. Once the best hyperparameters were identified, alpha was changed to 0.025 (e.g., 2.5th percentile) and 0.975 (e.g., 97.5th percentile) to estimate AGBD uncertainty).

| Hyperparameter | Range | |
|---|---|---|
| n_estimators | 1000 | |
| early_stopping_rounds | 50 | |
| loss/objective | “quantile” | |
| alpha* | 0.025, 0.5, 0.975 | |
| learning_rate | 0.1 | |
| max_depth | 2-15 | (step: 1) |
| num_leaves | 10-1000 | (step: 5) |
| boosting_type | “gbdt” | |
| subsample | 0.5-1.0 | (step: 0.1) |
| colsample_bytree | 0.5-1.0 | (step: 0.1) |
| min_child_samples | 20-1000 | (step: 5) |

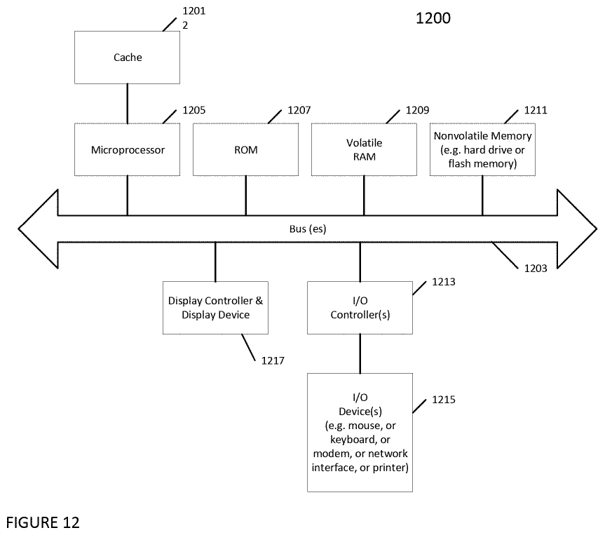

FIG. 12 shows one example of a data processing system 1200, which may be used with one embodiment of the present invention. For example, the system 1200 may be implemented as a system that includes a prediction model device 102 as shown in FIG. 1 above. Note that while FIG. 12 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 12, the computer system 1200, which is a form of a data processing system, includes a bus 1203 which is coupled to a microprocessor(s) 1205 and a ROM (Read Only Memory) 1207 and volatile RAM 1209 and a non-volatile memory 1211. The microprocessor 1205 may include one or more CPU(s), GPU(s), a specialized processor, and/or a combination thereof. The microprocessor 1205 may retrieve the instructions from the memories 1207, 1209, 1211 and execute the instructions to perform the operations described above. The bus 1203 interconnects these various components together and also interconnects these components 1205, 1207, 1209, and 1211 to a display controller and display device 1214 and to peripheral devices such as input/output (I/O) devices which may be mice, keyboards, modems, network interfaces, printers and other devices which are well known in the art. Typically, the input/output devices 1215 are coupled to the system through input/output controllers 1213. The volatile RAM (Random Access Memory) 1209 is typically implemented as dynamic RAM (DRAM), which requires power continually in order to refresh or maintain the data in the memory.

The mass storage 1211 is typically a magnetic hard drive or a magnetic optical drive or an optical drive or a DVD RAM or a flash memory or other types of memory systems, which maintain data (e.g., large amounts of data) even after power is removed from the system. Typically, the mass storage 1212 will also be a random access memory although this is not required. While FIG. 12 shows that the mass storage 1212 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 1203 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “training,” “creating,” “simulating,” “forwarding,” “retrieving,” “checking,” “allowing,” “augmenting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method of generating an above ground biomass density map of a target landmass, the method comprising:
receiving a first set of satellite and optionally environmental data for the target landmass;
training an above ground biomass density model using at least the satellite and Light Detection and Ranging (LIDAR) data; and
applying the above ground biomass density model using a second set of satellite and environmental data to generate the above ground biomass density map.

2. The non-transitory machine-readable medium of claim 1, wherein the method further comprises:
preprocessing the satellite data, wherein the preprocessed satellite data includes at least one of cloud masking data, shadow masking data, mosaicking data, and normalized difference spectral index calculation.

3. The non-transitory machine-readable medium of claim 2, wherein the method further comprises:
generating a normalized difference spectral index stack from the preprocessed satellite data.

4. The non-transitory machine-readable medium of claim 1, wherein the satellite imagery data includes at least one of multispectral satellite data and synthetic-aperture radar imagery data.

5. The non-transitory machine-readable medium of claim 1, wherein the LIDAR data includes global ecosystem dynamics investigation LIDAR data.

6. The non-transitory machine-readable medium of claim 1, wherein the environmental data includes climate data.

7. The non-transitory machine-readable medium of claim 1, wherein the environmental data includes land cover data.

8. The non-transitory machine-readable medium of claim 1, wherein the environmental data includes digital elevation model data.

9. The non-transitory machine-readable medium of claim 8, further comprising:
preprocessing the digital elevation model data; and
generating a digital elevation model stack from the preprocessed digital elevation model data.

10. The non-transitory machine-readable medium of claim 1, wherein the method further comprises:
receiving training data for the above ground biomass density model, wherein the training data includes at least one of satellite data and environmental data;
training the above ground biomass density model using light gradient boosted machine learning algorithm; and
outputting the above ground biomass density prediction model.

11. The non-transitory machine-readable medium of claim 10, wherein the method further comprises:
generating an above ground biomass density map using the above ground biomass density prediction model.

12. The non-transitory machine-readable medium of claim 10, wherein the training further includes using Bayesian optimization.

13. A method of generating an above ground biomass density map of a target landmass, the method comprising:
receiving a first set of satellite and optionally environmental data for the target landmass;
training an above ground biomass density model using at least the satellite and Light Detection and Ranging (LIDAR) data; and
applying the above ground biomass density model using a second set of satellite and environmental data to generate the above ground biomass density map.

14. The method of claim 13, wherein the method further comprises:
preprocessing the satellite data, wherein the preprocessed satellite data includes at least one of cloud masking data, shadow masking data, mosaicking data, and normalized difference spectral index calculation.

15. The method of claim 14, wherein the method further comprises:
generating a normalized difference spectral index stack from the preprocessed satellite data.

16. The method of claim 13, wherein the satellite imagery data includes at least one of multispectral satellite data and synthetic-aperture radar imagery data.

17. The method of claim 13, wherein the LIDAR data includes global ecosystem dynamics investigation LIDAR data.

18. The method of claim 13, wherein the environmental data includes climate data.

19. The method of claim 13, wherein the environmental data includes land cover data.

20. The method of claim 13, wherein the environmental data includes digital elevation model data.
